(19) United States
(12) Patent Application Publication
(10) Pub. No.: US 2011/0264350 A1
(43) Pub. Date: Oct. 27, 2011

(54) VEHICLE

(75) Inventor: Katsunori Doi, Tokyo (JP)

(73) Assignee: EQUOS RESEARCH CO., LTD., TOKYO (JP)

(21) Appl. No.: 13/063,149

(22) PCT Filed: Oct. 16, 2009
(86) PCT No.: PCT/JP2009/005418

§ 371 Date: Mar. 9, 2011

(30) Foreign Application Priority Data
Oct. 22, 2008 (JP) 2008-272342
Oct. 22, 2008 (JP) 2008-272364

(51) Int. Cl. B60L 15/20

(52) U.S. Cl. 701/90

(57) ABSTRACT

Disclosed is a vehicle which makes it possible to control the vehicle traveling state and the vehicle attitude with a high degree of precision, even when the vehicle is traveling quickly, and affords safe and pleasant travel for a range of traveling conditions, by the appropriate correction of the drive torque of a drive wheel in response to the traveling velocity of the vehicle and the position of the center of gravity of the vehicle body. For this purpose, the vehicle comprises a drive wheel rotatably mounted on the vehicle body, and a vehicle control device for controlling the drive torque imparted to the drive wheel to control the attitude of the vehicle. The vehicle control device causes the center of gravity of the vehicle body to move relative to the drive wheel by an amount corresponding to the rotational angular velocity of the drive wheel in the direction of travel of the drive wheel.

### TECHNICAL FIELD

The present invention relates to a vehicle that utilizes inverted-pendulum attitude control.

### BACKGROUND ART

Vehicles that utilize inverted-pendulum attitude control are proposed in the related art. For example, there are proposed a vehicle that includes two drive wheels disposed on the same axis and that is driven while sensing changes in attitude of a vehicle body caused by an operator by moving his/her center of gravity and a vehicle that moves while controlling the attitude of a vehicle body attached to a single spherical drive wheel (see Patent Document 1, for example).

These vehicles are moved and stopped by controlling the operation of rotating bodies, while detecting the balance of the vehicle body and the operating state using sensors.

### PRIOR ART DOCUMENT

### Patent Document

Patent Document 1: Japanese Patent Application Publication No. JP-A-2004-129435

### SUMMARY OF INVENTION

### Problem to be Solved by the Invention

In the above conventional vehicle, however, the standing attitude of the vehicle is kept by controlling the position of the center of gravity of the vehicle body according to the acceleration of the vehicle, and when the travel speed of the vehicle is high, the error in the control of the travel speed and the vehicle body attitude becomes large due to the influence of the air resistance acting on the vehicle body even when during a constant speed travel (the state where the acceleration of the vehicle is zero). Thus, the drivability and the ride comfort can be degraded.

When the running state and the vehicle body attitude are controlled according to the travel speed of the vehicle, the influence of the travel speed can be estimated based on predetermined parameters. In this case, however, if the actual parameter values differ from the setting values because of the difference(s) in the physique of the passenger and/or in the shape of the load, and/or the change with time of tribological characteristics, the error in the control of the travel speed and the vehicle body attitude can become large, which can result in the degradation of the drivability and the ride comfort.

An object of the present invention is to solve the above problems of the conventional vehicles, to provide a vehicle, of which the running state and the vehicle body attitude can be precisely controlled even during high speed travel by appropriately correcting the drive torque of a drive wheel and the position of the center of gravity of the vehicle body based on the travel speed of the vehicle, and that can therefore provide a safe and comfortable drive under various driving conditions, and to provide a vehicle, with which it is possible to perform the posteriori estimation and the correction of parameters by estimating the speed-dependent resistance torques, which are the influences on the vehicle depending on the travel speed, based on the time histories of the rotational state of the drive wheel, the position of the center of gravity of the vehicle body, the drive torque, etc., so that the running state and the vehicle body attitude can be precisely controlled so as to adapt to the travel speed according to various use conditions and use histories and a safe and comfortable drive is therefore provided.

### Means for Solving the Problem

Thus, a vehicle according to the present invention includes a drive wheel rotatably attached to a vehicle body; and a vehicle control device that controls an attitude of the vehicle body by controlling a drive torque applied to the drive wheel, wherein the vehicle control device moves the center of gravity of the vehicle body relative to the drive wheel in the advancing direction of the drive wheel by the amount according to the rotational angular speed of the drive wheel.

In another vehicle according to the present invention, the vehicle control device moves the center of gravity of the vehicle body by inclining the vehicle body.

Another vehicle according to the present invention further includes an active weight portion attached to the vehicle body so as to be movable with respect to the vehicle body, wherein the vehicle control device moves the center of gravity of the vehicle body by moving the active weight portion.

Another vehicle according to the present invention further includes an estimation means that estimates, based on the rotational angular speed of the drive wheel, a speed-dependent resistance torque or torques that is/are a resistance torque acting on the drive wheel according to the vehicle speed and/or a resistance torque acting on the vehicle body according to the vehicle speed, wherein the vehicle control device moves the center of gravity of the vehicle body based on the speed-dependent resistance torque or torques estimated by the estimation means.

In another vehicle according to the present invention, in addition, the estimation means estimates a vehicle body air resistance torque, which is a torque due to an air resistance acting on the vehicle body, and/or a drive-wheel frictional resistance, which is a frictional resistance that impedes rotation of the drive wheel, and/or a reactive torque related to the air resistance.

Another vehicle according to the present invention includes a drive wheel rotatably attached to a vehicle body; a vehicle control device that controls an attitude of the vehicle body by controlling a drive torque applied to the drive wheel; and an air speed measurement means that measures an air speed, wherein the vehicle control device moves the center of gravity of the vehicle body relative to the drive wheel in a direction of the air speed by the amount according to the air speed.

Another vehicle according to the present invention includes a drive wheel rotatably attached to a vehicle body; and a vehicle control device that controls an attitude of the vehicle body by controlling a drive torque applied to the drive wheel, wherein the vehicle control device includes an estimation means that estimates a speed-dependent resistance torque or torques that is/are a resistance torque acting on the drive wheel according to the vehicle speed and/or a resistance torque acting on the vehicle body according to the vehicle speed based on a time history of a rotational state of the drive wheel, and/or a time history of a position of the center of gravity of the vehicle body, and/or a time history of the drive torque.

In another vehicle according to the present invention, in addition, the estimation means performs the estimation based on at least one of a time history of a rotational angular speed of the drive wheel, a time history of a rotational angular acceleration of the drive wheel, and a time history of an inclination angle of the vehicle body.

Another vehicle according to the present invention further includes an active weight portion attached to the vehicle body so as to be movable with respect to the vehicle body, wherein the estimation means performs the estimation based on a time history of a relative position of the active weight portion with respect to the drive wheel.

In another vehicle according to the present invention, in addition, the estimation means estimates a vehicle body air resistance, which is an air resistance acting on the vehicle body, and/or a vehicle body air resistance torque, which is a torque acting on the vehicle body due to the air resistance, and/or a drive-wheel frictional resistance torque, which is a frictional resistance that impedes rotation of the drive wheel.

In another vehicle according to the present invention, in addition, the estimation means inhibits using, in estimating the speed-dependent resistance torque or torques, the time history within a period of time, during which a movement speed or a movement acceleration of the center of gravity of the vehicle body is equal to or higher than respective threshold values.

In another vehicle according to the present invention, in addition, the estimation means corrects the estimated speed-dependent resistance torque or torques using, as an offset value, the speed-dependent resistance torque or torques that is/are estimated when a rotational angular speed of the drive wheel is equal to or lower than a predetermined threshold.

In another vehicle according to the present invention, the vehicle control device further includes a parameter determination means that determines a speed-dependent resistance parameter that is a parameter of correlation between a rotational angular speed of the drive wheel or the rotational angular speed to at least the second power and the speed-dependent resistance speed-dependent resistance torque or torques, based on a time history of a rotational angular speed of the drive wheel and a time history or histories of the estimated speed-dependent resistance torque or torques, wherein the estimation means estimates the speed-dependent resistance torque or torques based on the speed-dependent resistance parameter.

In another vehicle according to the present invention, in addition, the parameter determination means determines at least one of a vehicle body air resistance coefficient, which is a ratio between the air resistance and a rotational angular speed of the drive wheel or the rotational angular speed to at least the second power, a vehicle body air resistance center height, which is a height of a center of action of the vehicle body air resistance, and a drive wheel frictional resistance coefficient, which is a ratio between the frictional resistance of the drive wheel and the rotational angular speed of the drive wheel or the rotational angular speed to at least the second power.

In another vehicle according to the present invention, in addition, the parameter determination means determines the speed-dependent resistance parameter by least squares method applied to correlative data between the rotational angular speed of the drive wheel and the estimated speed-dependent resistance torque or torques taken between a current time and a time preceding to the current time by a predetermined time period.

In another vehicle according to the present invention, the vehicle control device further includes an attitude control means that controls an attitude of the vehicle body according to the speed-dependent resistance torque or torques estimated by the estimation means.

### Effects of the Invention

According to the configuration of Claim 1, the travel speed of the vehicle is easily estimated and the position of the center of gravity of the vehicle body is moved to a proper position according to the travel speed, so that it is possible to stably control the running state and the vehicle body attitude with high precision even during high speed travel.

According to the configuration of Claim 2, it is possible to easily achieve the movement of the center of gravity of the vehicle body without adding any additional mechanism for moving the center of gravity.

According to the configuration of Claim 3, the position of the center of gravity of the vehicle body is moved without inclining the vehicle body, so that the ride comfort is improved

According to the configuration of Claim 4, the influence on the vehicle depending on the travel speed is estimated and based on this estimation, the position of the center of gravity of the vehicle body is appropriately set, so that it is possible to control the running state and the vehicle body attitude with higher precision.

According to the configuration of Claim 5, the influence on the vehicle depending on the travel speed is more exactly estimated, so that it is possible to control the running state and the vehicle body attitude with even higher precision.

According to the configuration of Claim 5, in addition, the correct travel speed is obtained even while the drive wheel is spinning, so that it is possible to stably control the running state and the vehicle body attitude according to the travel speed.

According to the configuration of Claim 6, the speed-dependent resistance torque or torques is/are estimated based on the relation between inputs and the running state of the vehicle and/or the change of the vehicle body attitude without using predetermined parameters, so that it is possible to accurately estimate the speed-dependent resistance torque or torques irrespective of the change of the parameters depending on the use state and/or the use history of the vehicle.

According to the configuration of Claim 7, there is no need to separately provide a special sensor for estimating the speed-dependent resistance torque or torques and it is possible to perform the estimation with the sensors only that are required to perform the inverted-pendulum control.

According to the configuration of Claim 8, it is possible to perform the estimation with higher accuracy by employing the information on the position of the active weight portion.

According to the configuration of Claim 9, the influence of the travel speed on the running state and/or the vehicle body attitude is taken into consideration more appropriately by treating the influence on the vehicle depending on the travel speed in a more detailed manner.

According to the configuration of Claim 10, the estimation of the speed-dependent resistance torque or torques while it is expected that the error is large because the accurate estimation is difficult, is actively avoided, so that it is possible to perform the estimation with higher accuracy.

According to the configuration of Claim 11, the influence of the offset value is easily eliminated from the estimated value(s) of the speed-dependent resistance torque or torques.

According to the configuration of Claim 12, the change in parameters depending on the use state and/or the use history of the vehicle is properly taken into consideration by estimating the speed-dependent resistance parameter and in addition, stable estimation and adaptive control depending thereon are performed by indirectly reflecting the result of the estimation of the speed-dependent resistance parameter on the estimated value(s) of the speed-dependent resistance torque or torques.

According to the configuration of Claim 13, it is possible to more accurately estimate the speed-dependent resistance torque or torques by treating the influence on the vehicle depending on the travel speed and the parameter thereof in a more detailed manner.

According to the configuration of Claim 14, it is possible to more easily estimate the correlation between the travel speed and the speed-dependent resistance torque or torques and estimate the speed-dependent resistance parameter.

According to the configuration of Claim 14, in addition, the vehicle body attitude control is performed according to the estimated speed-dependent resistance torque or torques, so that the attitude of the vehicle body is ideally controlled and the ride comfort is improved.

### BRIEF DESCRIPTION OF THE DRAWINGS

FIG. 1 is a schematic diagram showing a configuration of a vehicle according to a first embodiment of the present invention, showing a state in which the vehicle is accelerating forward with a passenger riding on the vehicle.

FIG. 2 is a block diagram showing a configuration of a control system for the vehicle according to the first embodiment of the present invention.

FIG. 3 is a schematic diagram showing an operation of the vehicle according to the first embodiment of the present invention during high speed travel.

FIG. 4 is a flowchart showing the procedures of the running and attitude control process for the vehicle according to the first embodiment of the present invention.

FIG. 5 illustrates a dynamic model of the vehicle according to the first embodiment of the present invention and parameters of the dynamic model.

FIG. 6 is a flowchart showing procedures of a state quantity acquisition process according to the first embodiment of the present invention.

FIG. 7 is a flowchart showing procedures of a target running state determination process according to the first embodiment of the present invention.

FIG. 8 is a graph showing changes in target value of an active weight portion position and changes in target value of a vehicle body inclination angle according to the first embodiment of the present invention.

FIG. 9 is a flowchart showing procedures of a target vehicle body attitude determination process according to the first embodiment of the present invention.

FIG. 10 is a flowchart showing procedures of an actuator output determination process according to the first embodiment of the present invention.

FIG. 11 is a block diagram showing a configuration of a control system for a vehicle according to a second embodiment of the present invention.

FIG. 12 is a schematic diagram showing an operation of a vehicle according to the second embodiment of the present invention during high speed travel.

FIG. 13 is a flowchart showing procedures of a state quantity acquisition process according to the second embodiment of the present invention.

FIG. 14 is a flowchart showing procedures of a target vehicle body attitude determination process according to the second embodiment of the present invention.

FIG. 15 is a flowchart showing procedures of an actuator output determination process according to the second embodiment of the present invention.

FIG. 16 is a block diagram showing a configuration of a control system for a vehicle according to a third embodiment of the present invention.

FIG. 17 is a flowchart showing procedures of a state quantity acquisition process according to the third embodiment of the present invention.

FIG. 18 is a flowchart showing procedures of a target vehicle body attitude determination process according to the third embodiment of the present invention.

FIG. 19 is a flowchart showing procedures of an actuator output determination process according to the third embodiment of the present invention.

FIG. 20 is a diagram showing the estimation of parameters of the drive wheel speed-dependent resistance torque according to a fourth embodiment of the present invention.

FIG. 21 is a diagram showing the estimation of parameters of a vehicle body speed-dependent resistance torque according to the fourth embodiment of the present invention.

FIG. 22 is a flowchart showing procedures of a state quantity acquisition process according to the fourth embodiment of the present invention.

### Embodiments FOR CARRYING OUT THE INVENTION

Embodiments of the present invention will be described in detail below with reference to the drawings.

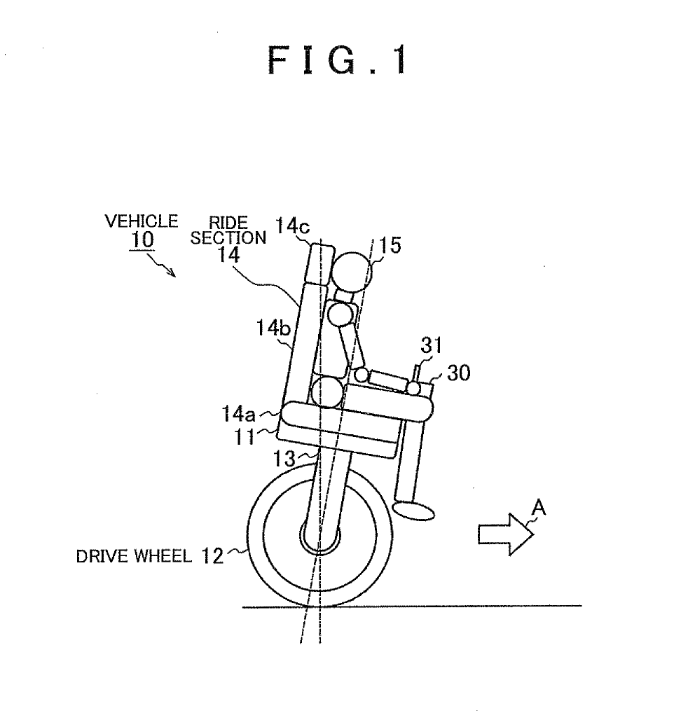

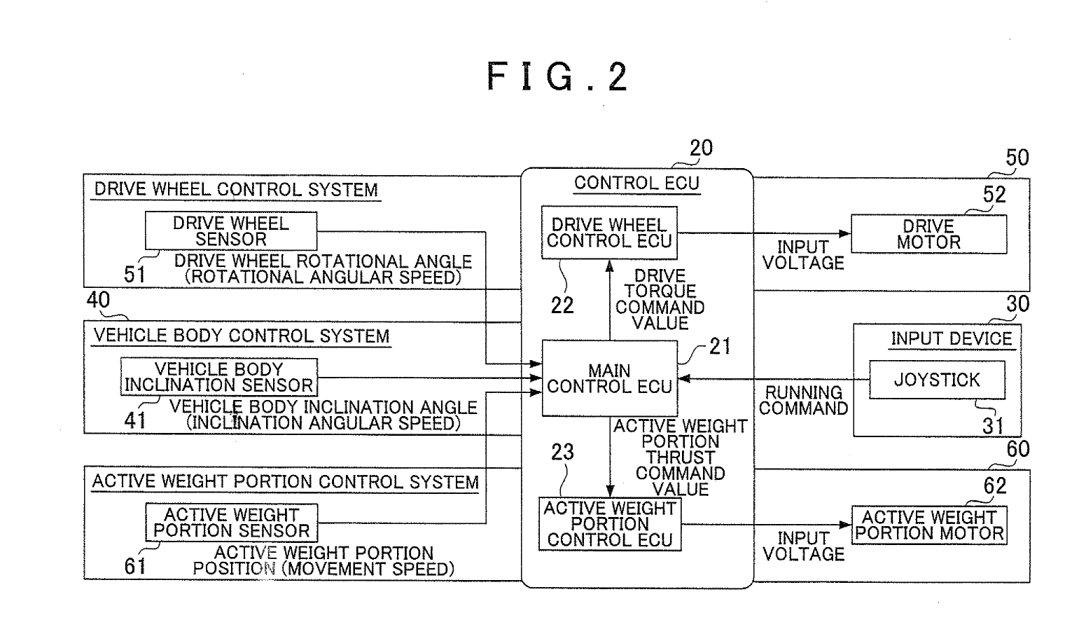

FIG. 1 is a schematic diagram showing a configuration of a vehicle according to a first embodiment of the present invention, showing a state in which the vehicle is accelerating forward with a passenger riding on the vehicle. FIG. 2 is a block diagram showing a configuration of a control system for the vehicle according to the first embodiment of the present invention.

In the drawings, reference numeral 10 denotes a vehicle according to an embodiment. The vehicle 10 includes a main body portion 11 of a vehicle body, drive wheels 12, a support portion 13, and a ride section 14 ridden by a passenger 15. The attitude of the vehicle body is controlled utilizing inverted-pendulum attitude control. The vehicle body of the vehicle 10 can be inclined forward and rearward. In the example shown in FIG. 1, the vehicle 10 is accelerating in the direction indicated by the arrow A with the vehicle body inclined forward in the advancing direction.

The drive wheels 12 are rotatably supported by the support portion 13 that is a part of the vehicle body, and are driven by drive motors 52 serving as drive actuators. The axis of the drive wheels 12 extends in the direction perpendicular to the drawing sheet of FIG. 1 and the drive wheels 12 rotate about the axis. Any number (single or multiple) of drive wheels 12 may be provided. In the case where a plurality of drive wheels 12 are provided, the drive wheels 12 are disposed in parallel on the same axis. Description will be made with the assumption that two drive wheels 12 are provided in the case of this embodiment. In this case, the drive wheels 12 are independently driven by separate drive motors 52. While a hydraulic motor or an internal combustion engine, for example, may be used as the drive actuator, description will be made with the assumption that the drive motors 52 that are electric motors are used in this embodiment.

The main body portion 11, which is a part of the vehicle body, is supported by the support portion 13 from below and positioned above the drive wheels 12. The ride section 14, which functions as an active weight portion, is attached to the main body portion 11 so as to be relatively translatable with respect to the main body portion 11 in the front-rear direction of the vehicle 10, in other words, so as to be relatively movable in the direction of a tangent to a circle representing rotation of the vehicle body.

The active weight portion has a certain mass, and is translated with respect to the main body portion 11, that is, moved forward and rearward, to actively correct the position of the center of gravity of the vehicle 10. The active weight portion is not necessarily the ride section 14, and may be a device formed by attaching a heavy peripheral device such as a battery to the main body portion 11 so as to be translatable, or may be a device formed by attaching a dedicated weight member such as a weight, a weight (omori) or a balancer to the main body portion 11 so as to be translatable, for example. The ride section 14, a heavy peripheral device, and a dedicated weight member may be used in combination.

While the ride section 14 ridden by the passenger 15 functions as an active weight portion in this embodiment for the convenience of description, the ride section 14 is not necessarily ridden by the passenger 15. For example, in the case where the vehicle 10 is manipulated by remote control, it is not necessary that the ride section 14 is ridden by the passenger 15 and a piece of freight may be placed on the ride section 14 in place of the passenger 15.

The ride section 14 is similar to a seat for use in automobiles such as passenger cars and buses. The ride section 14 includes a seat surface portion 14a, a backrest portion 14b, and a headrest 14c, and is attached to the main body portion 11 via a movement mechanism (not shown).

The movement mechanism includes a low-resistance linear movement mechanism such as a linear guide device, and an active weight portion motor 62 serving as an active weight portion actuator. The active weight portion motor 62 drives the ride section 14 to move the ride section 14 with respect to the main body portion 11 forward and rearward in the advancing direction. While a hydraulic motor or a linear motor, for example, may be used as the active weight portion actuator, description will be made with the assumption that the active weight portion motor 62 that is a rotary electric motor is used in this embodiment.

The linear guide device includes, for example, a guide rail attached to the main body portion 11, a carriage attached to the ride section 14 to slide along the guide rail, and rolling elements, such as balls and rollers, interposed between the guide rail and the carriage. The guide rail has two track grooves formed in left and right side surfaces to extend linearly along the longitudinal direction. The carriage is formed to have a U-shaped cross section, and has two track grooves formed in inner sides of two opposing side surfaces to respectively oppose the track grooves of the guide rail. The rolling elements are embedded between the track grooves to roll in the track grooves as the guide rail and the carriage move linearly with respect to each other. The carriage is formed to have a return passage that connects both ends of the track groove to allow the rolling elements to circulate through the track groove and the return passage.

The linear guide device also includes a brake or a clutch that locks movement of the linear guide device. When movement of the ride section 14 is not necessary, for example when the vehicle 10 is stationary, the brake is engaged to fix the carriage with respect to the guide rail in order to retain the relative positional relationship between the main body portion 11 and the ride section 14. When movement of the ride section 14 is necessary, the brake is disengaged to control the distance between the reference position of the main body portion 11 and the reference position of the ride section 14 to a predetermined value.

An input device 30 is disposed beside the ride section 14. The input device 30 includes a joystick 31 serving as a target running state acquisition device. The passenger 15 operates the joystick 31, which is an operation device, to operate the vehicle 10, that is, to issue a running command for causing the vehicle 10 to accelerate, decelerate, make a turn, rotate on the spot, stop, brake, and so forth. In place of the joystick 31, another device, such as a jog dial, a touch panel, and a push button, that is operated by the passenger 15 to issue a running command may be used as the target running state acquisition device.

In the case where the vehicle 10 is manipulated by remote control, a reception device, in place of the joystick 31, that receives a running command from a controller via a wire or wirelessly may be used as the target running state acquisition device. In the case where the vehicle 10 runs automatically in accordance with running command data determined in advance, a data read device, in place of the joystick 31, that reads running command data stored in a storage medium such as a semiconductor memory or a hard disk may be used as the target running state acquisition device.

The vehicle 10 also includes a control ECU (Electronic Control Unit) 20 serving as a vehicle control device. The control ECU 20 includes a main control ECU 21, a drive wheel control ECU 22, and an active weight portion control ECU 23. Each of the control ECU 20 and the main control ECU 21, the drive wheel control ECU 22, and the active weight portion control ECU 23 is a computer system that includes a computation means such as a CPU or a MPU, a storage means such as a magnetic disk or a semiconductor memory, an input/output interface, and so forth and that controls operation of respective portions of the vehicle 10. The main control ECU 21, the drive wheel control ECU 22, and the active weight portion control ECU 23 may be formed separately from or integrally with each other.

The main control ECU 21, together with the drive wheel control ECU 22, a drive wheel sensor 51, and the drive motors 52, functions as a part of a drive wheel control system 50 that controls operation of the drive wheels 12. The drive wheel sensor 51 includes a resolver, an encoder, etc., and functions as a drive wheel rotational state measurement device. The drive wheel sensor 51 detects a drive wheel rotational angle and/or a rotational angular speed that indicates the rotational state of the drive wheels 12 to transmit the detection results to the main control ECU 21. The main control ECU 21 transmits a drive torque command value to the drive wheel control ECU 22. The drive wheel control ECU 22 supplies the drive motors 52 with an input voltage that is equivalent to the received drive torque command value. The drive motors 52 provide a drive torque to the drive wheels 12 in accordance with the input voltage. The drive motors 52 thus function as drive actuators.

Also, the main control ECU 21, together with the active weight portion control ECU 23, an active weight portion sensor 61, and the active weight portion motor 62, functions as a part of an active weight portion control system 60 that controls operation of the ride section 14 serving as an active weight portion. The active weight portion sensor 61 includes an encoder etc., and functions as an active weight portion movement state measurement device. The active weight portion sensor 61 detects an active weight portion position and/or a movement speed that indicates the movement state of the ride section 14 to transmit the detection results to the main control ECU 21. The main control ECU 21 transmits an active weight portion thrust command value to the active weight portion control ECU 23. The active weight portion control ECU 23 supplies the active weight portion motor 62 with an input voltage that is equivalent to the received active weight portion thrust command value. The active weight portion motor 62 provides thrust for translating the ride section 14 in accordance with the input voltage. The active weight portion motor 62 thus functions as an active weight portion actuator.

Further, the main control ECU 21, together with the drive wheel control ECU 22, the active weight portion control ECU 23, a vehicle body inclination sensor 41, the drive motors 52, and the active weight portion motor 62, functions as a part of a vehicle body control system 40 that controls the attitude of the vehicle body. The vehicle body inclination sensor 41 includes an acceleration sensor, a gyro sensor, etc., and functions as a vehicle body inclination state measurement device. The vehicle body inclination sensor 41 detects a vehicle body inclination angle and/or an inclination angular speed that indicates the inclination state of the vehicle body to transmit the detection results to the main control ECU 21. The main control ECU 21 transmits the drive torque command value to the drive wheel control ECU 22, and transmits the active weight portion thrust command value to the active weight portion control ECU 23.

The main control ECU 21 receives the running command from the joystick 31 of the input device 30. The main control ECU 21 transmits the drive torque command value to the drive wheel control ECU 22, and transmits the active weight portion thrust command value to the active weight portion control ECU 23.

The control ECU 20 functions as an estimation means that estimates a speed-dependent resistance torque based on a vehicle speed (rotational angular speed of drive wheels 12). In addition, the control ECU 20 functions as an attitude control means that controls the attitude of the vehicle body based on the estimated speed-dependent resistance torque.

The speed-dependent resistance is a resistance that increases with the increase in travel speed. In this embodiment, the resistances, such as the air resistance acting on the vehicle body, and the viscous friction acting on a rotary shaft of the drive wheels 12, are taken into consideration as the speed-dependent resistance.

The estimation means estimates a vehicle body air resistance torque, which is a torque due to the air resistance acting on the vehicle body, a drive-wheel frictional resistance, which is the frictional resistance that impedes the rotation of the drive wheels 12, and a reactive torque related to the air resistance. The attitude control means moves the position of the center of gravity by moving the ride section 14, which functions as the active weight portion.

The respective sensors may be configured to acquire a plurality of state quantities. For example, an acceleration sensor and a gyro sensor may be used in combination as the vehicle body inclination sensor 41 to determine a vehicle body inclination angle and an inclination angular speed based on measurement values of both the sensors.

Next, the operation of the vehicle 10 configured as described above will be described. First, an outline of a running and attitude control process is described.

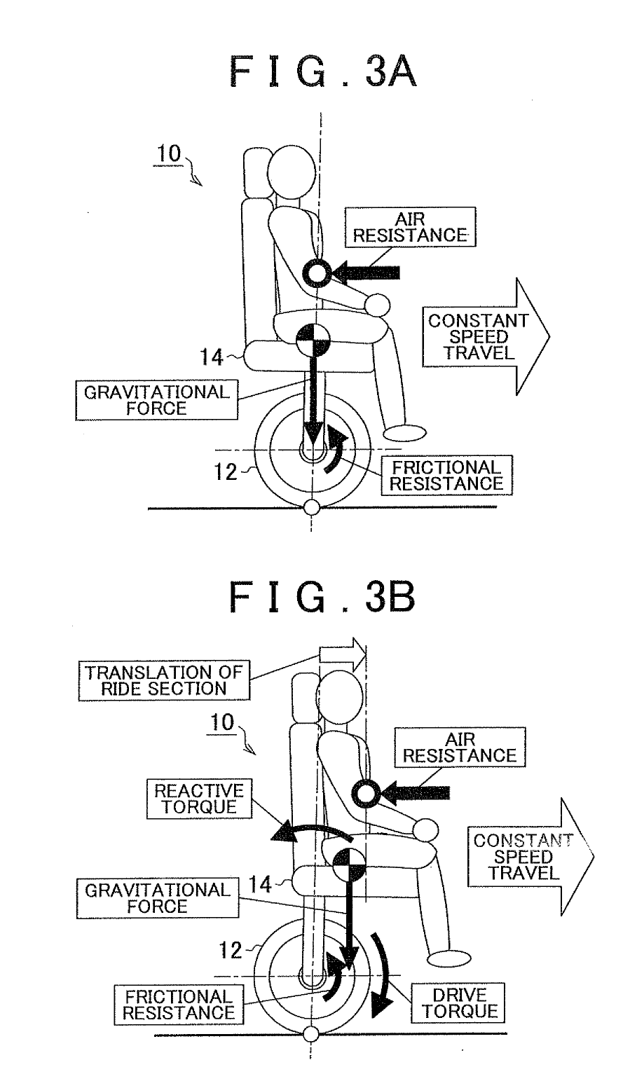

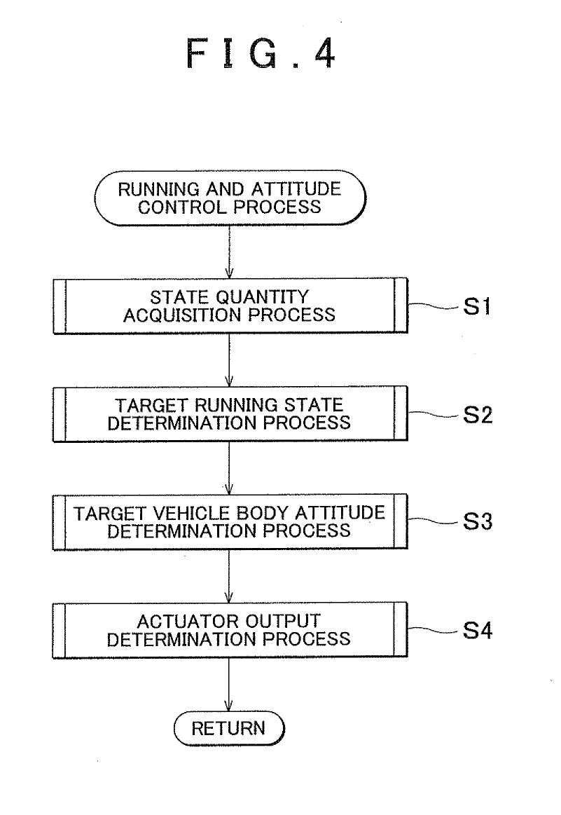

FIG. 3 is a schematic diagram showing the operation of the vehicle according to the first embodiment of the present invention during high speed travel. FIG. 4 is a flowchart showing the procedures of the running and attitude control process for the vehicle according to the first embodiment of the present invention. FIG. 3A shows exemplary operation according to the related art for comparison. FIG. 3B shows operation according to this embodiment.

In this embodiment, the drive torque for the drive wheels 12 and the position of the center of gravity of the vehicle body are corrected based on the travel speed of the vehicle 10. Specifically, the drive torque is added to cancel the speed-dependent resistance torque (viscous drag torque) and the position of the center of gravity of the vehicle 10 is actively corrected by moving the ride section 14, which functions as the active weight portion, in the advancing direction of the vehicle 10 as shown in FIG. 3B so that the air resistance torque acting on the vehicle body and the reactive torque that is the reaction to the added drive torque are canceled by the gravitational force torque produced by the movement of the center of gravity of the vehicle body. In this way, even during high speed travel, it is possible to control the running state and the attitude of the vehicle body with high precision. As a result, it becomes possible to provide the inverted-pendulum vehicle 10 that is better in drivability and ride comfort.

In the case where the drive torque for the drive wheels 12 and the position of the center of gravity of the vehicle body are not corrected based on the travel speed as in the vehicles according to the related art described in the BACKGROUND ART section, in contrast, the error in the control of the travel speed and the attitude of the vehicle body increases with the increase in the travel speed. In other words, in the case of the inverted-pendulum vehicles, as shown in FIG. 3A, when the vehicle speed increases, the speed-dependent resistance, that is, the air resistance acting on the vehicle 10 and the resistance, such as the viscous friction acting on the rotary shaft of the drive wheels 12, also increase and the influence thereof on the running and attitude control increases.

Specifically, there is a possibility that the vehicle speed becomes lower than the target value because of the speed-dependent resistance. In addition, there is a possibility that the vehicle body is inclined rearward due to the air resistance torque acting on the vehicle body and the reactive torque acting on the vehicle body when the drive torque for canceling the speed-dependent resistance is added.

As a result, the drivability and the ride comfort, which are important in terms of the mobility, are degraded. In particular, general inverted-pendulum vehicles have a large projected area in relation to the weight and have a shape that is short in the front-rear direction; so that the general inverted-pendulum vehicles are susceptible to the air resistance. The influence of the air resistance also affects the attitude control of the vehicle body. Thus, the measure thereagainst is important.

In this embodiment, thus, the running and attitude control process is executed to correct the drive torque for the drive wheels 12 and the position of the center of gravity of the vehicle body based on the travel speed of the vehicle 10, so that the vehicle 10 can stably run even when the travel speed of the vehicle 10 increases.

In the running and attitude control process, the control ECU 20 first executes a state quantity acquisition process (step S1) to acquire the rotational state of the drive wheels 12, the inclination state of the vehicle body, and the movement state of the ride section 14 using the respective sensors, that is, the drive wheel sensor 51, the vehicle body inclination sensor 41, and the active weight portion sensor 61.

The control ECU 20 then executes a target running state determination process (step S2) to determine a target value of the acceleration of the vehicle 10 and a target value of the rotational angular speed of the drive wheels 12 based on the amount of operation of the joystick 31.

The control ECU 20 then executes a target vehicle body attitude determination process (step S3) to determine a target value of the vehicle body attitude, that is, a target value of the vehicle body inclination angle and a target value of the active weight portion position, based on the target value of the acceleration of the vehicle 10 and the target value of the rotational angular speed of the drive wheels 12 determined in the target running state determination process.

The control ECU 20 finally executes an actuator output determination process (step S4) to determine outputs of the respective actuators, that is, respective outputs of the drive motors 52 and the active weight portion motor 62, on the basis of the respective state quantities acquired in the state quantity acquisition process, the target running state determined in the target running state determination process, and the target vehicle body attitude determined in the target vehicle body attitude determination process.

Next, the running and attitude control process will be described in detail. The state quantity acquisition process is first described.

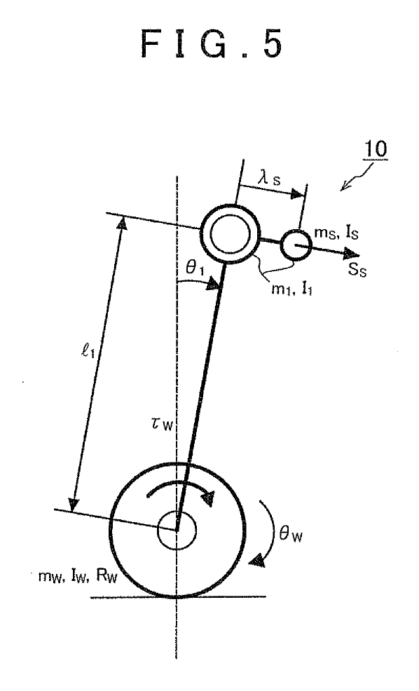

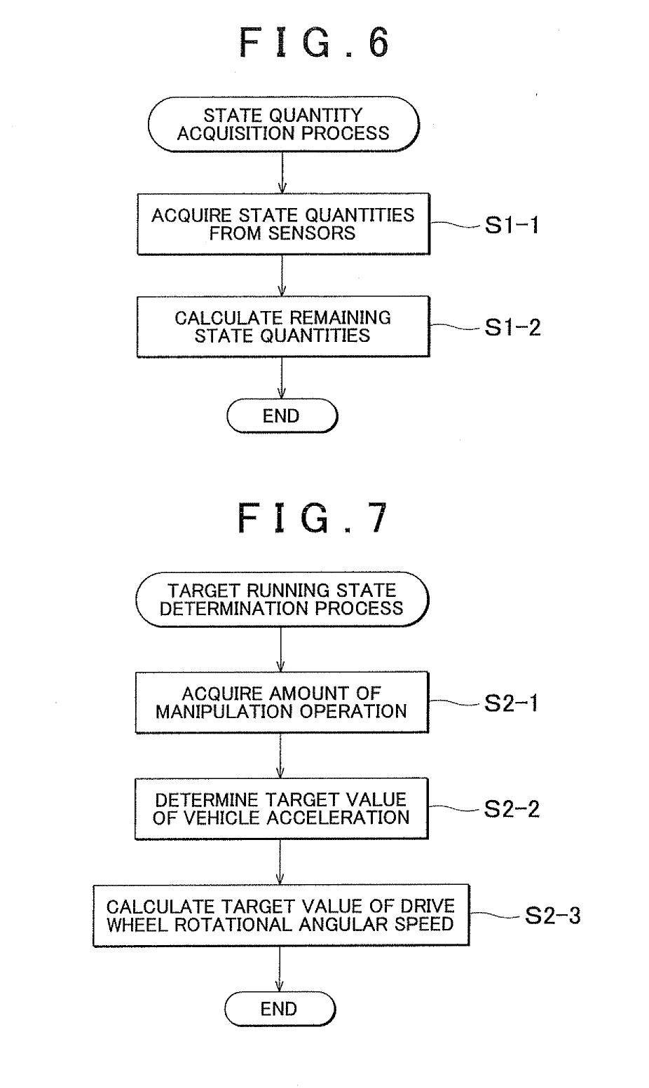

FIG. 5 illustrates a dynamic model of the vehicle according to the first embodiment of the present invention and parameters of the dynamic model. FIG. 6 is a flowchart showing the procedures of the state quantity acquisition process according to the first embodiment of the present invention.

The state quantities, input data, the parameters, the physical constants, etc. used in this embodiment are represented by the following symbols. Part of the state quantities and the parameters are shown in FIG. 5.

### State Quantities

θ_{W}: Drive wheel rotational angle (rad)

θ₁: Vehicle body inclination angle (with reference to the plumb line) (rad)
λ_{S}: Active weight portion position (with reference to the vehicle body center) (m)

### Input Data

τ_{W}: Drive torque (sum for the two drive wheels) (Nm)

S_{S}: Active weight portion thrust (N)

### Parameters

m_{W}: Mass of the drive wheels (sum for the two drive wheels) (kg)

R_{W}: Drive wheel ground contact radius (m)
I_{W}: Moment of inertia of the drive wheels (sum for the two drive wheels) (kgm²)
m₁: Mass of the vehicle body (including the active weight portion) (kg)
l₁: Distance to the center of gravity of the vehicle body (from the axle) (m)
I₁: Moment of inertia of the vehicle body (around the center of gravity) (kgm²)
m_{S}: Mass of the active weight portion (kg)
l_{S}: Distance to the center of gravity of the active weight portion (from the axle) (m)
I_{S}: Moment of inertia of the active weight portion (around the center of gravity) (kgm²)

### Physical Constants

g: Gravitational acceleration (m/s²)

In the state quantity acquisition process, the main ECU 21 first acquires state quantities from the sensors (step S1-1). In this step, the drive wheel rotational angle θ_{W} and/or the rotational angular speed \dot{θ}_{W} is/are acquired from the drive wheel sensor 51, the vehicle body inclination angle θ₁ and/or the inclination angular speed \dot{θ}₁ is/are acquired from the vehicle body inclination sensor 41, and the active weight portion position λ_{S} and/or the movement speed \dot{λ}_{S} is/are acquired from the active weight portion sensor 61.

The main ECU 21 subsequently calculates the remaining state quantities (step S1-2). In this step, the remaining state quantities are calculated by differentiating or integrating the acquired state quantities with respect to time. When the acquired state quantities are the drive wheel rotational angle θ_{W}, the vehicle body inclination angle θ₁, and the active weight portion position λ_{S}, for example, by differentiating these state quantities with respect to time, the rotational angular speed \dot{θ}_{W}, the inclination angular speed \dot{θ}₁, and the movement speed \dot{λ}_{S} are obtained. When the acquired state quantities are the rotational angular speed \dot{θ}_{W}, the inclination angular speed \dot{θ}₁, and the movement speed \dot{λ}_{S}, for example, by integrating these state quantities with respect to time, the drive wheel rotational angle θ_{W}, the vehicle body inclination angle θ₁, and the active weight portion position λ_{S} are obtained.

Next, the target running state determination process will be described.

FIG. 7 is a flowchart showing the procedures of the target running state determination process according to the first embodiment of the present invention.

In the target running state determination process, the main control ECU 21 first acquires the amount of manipulation operation (step S2-1). In this step, the main control ECU 21 acquires the amount of operation of the joystick 31 performed by the passenger 15 to issue a running command for causing the vehicle 10 to accelerate, decelerate, make a turn, rotate on the spot, stop, brake, and so forth.

The main control ECU 21 subsequently determines a target value of the vehicle acceleration on the basis of the acquired amount of operation of the joystick 31 (step S2-2). For example, the target value of the vehicle acceleration is set to a value that is proportional to the amount of operation of the joystick 31 in the front-rear direction.

The main control ECU 21 subsequently calculates a target value of the drive wheel rotational angular speed from the determined target value of the vehicle acceleration (step S2-3). For example, the target value of the drive wheel rotational angular speed is set to a value obtained by integrating the target value of the vehicle acceleration with respect to time and dividing the resulting value by the drive wheel ground contact radius RW.

Next, the target vehicle body attitude determination process will be described.

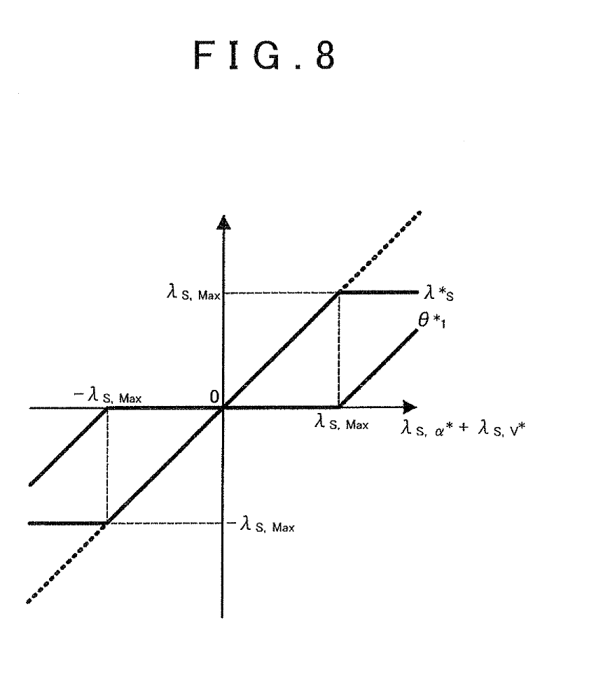

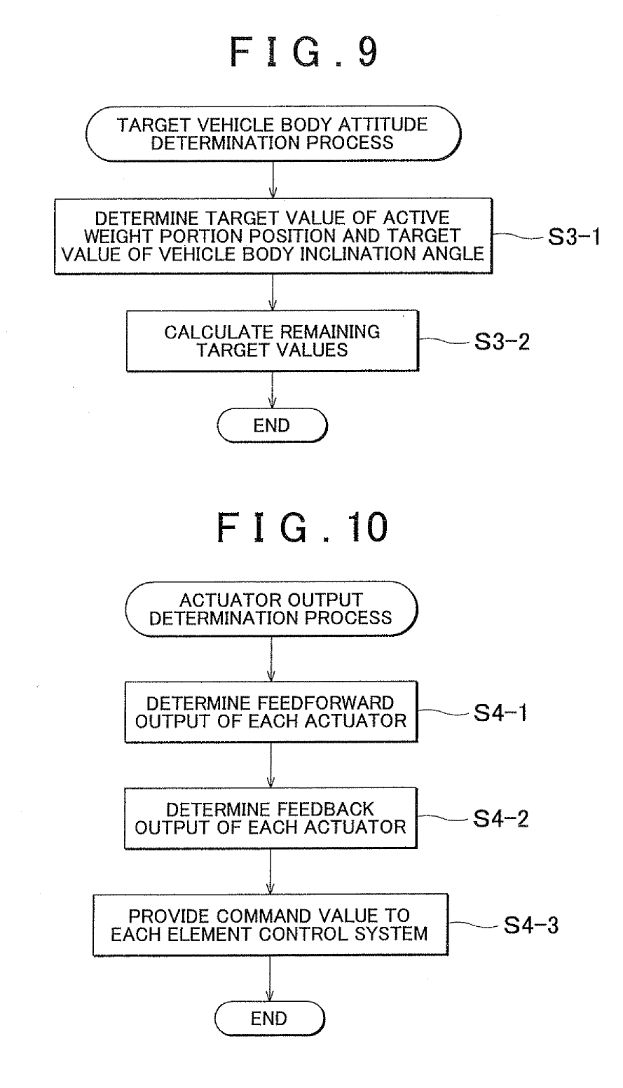

FIG. 8 is a graph showing changes in target value of the active weight portion position and changes in target value of the vehicle body inclination angle according to the first embodiment of the present invention. FIG. 9 is a flowchart showing the procedures of the target vehicle body attitude determination process according to the first embodiment of the present invention.

In the target vehicle body attitude determination process, the main control ECU 21 first determines a target value of the active weight portion position and a target value of the vehicle body inclination angle (step S3-1). In this step, the target value of the active weight portion position and the target value of the vehicle body inclination angle are determined, using Formula 1 and Formula 2 below, based on the target value of the vehicle acceleration and the target value of the drive wheel rotational angular speed determined in the target running state determination process.

(Expression 1)

When the target value of the vehicle acceleration is α* (G) and the target value of the drive wheel rotational angular speed is \dot{θ}*_{W} (rad/s), the target value of the active weight portion position, λ_{S}*, is expressed by Formula 1 below.

$${λ}_{S}^{*} = \{ \begin{matrix}- {λ}_{S , Max} & ( {λ}_{S , α}^{*} + {λ}_{S , V}^{*} \leq - {λ}_{S , Max} ) \\ {λ}_{S , α}^{*} + {λ}_{S , V}^{*} & ( - {λ}_{S , Max} < {λ}_{S , α}^{*} + {λ}_{S , V}^{*} < {λ}_{S , Max} ) \\ {λ}_{S , Max} & ( {λ}_{S , α}^{*} + {λ}_{S , V}^{*} \geq {λ}_{S , Max} )\end{matrix} \qquad Formula 1$$

In this formula,

$${λ}_{S , α}^{*} = \frac{{m}_{1} {l}_{1} + \tilde{M} {R}_{W}}{{m}_{S}} {α}^{*} and {λ}_{S , V}^{*} = \frac{{D}_{W} {\dot{θ}}_{W}^{*} + {D}_{1} {h}_{1 , D} {\dot{θ}}_{W}^{* 2}}{{m}_{S} g} .$$

In addition, M=m_{W}+m_{W}, and

$$\tilde{M} = M + \frac{{I}_{W}}{{R}_{W}^{2}} .$$

λ_{S,Max} is an active weight portion movement limit, which is set in advance based on, for example, the limit attributable to the structure of the movement mechanism that moves the ride section 14, which functions as the active weight portion.

λ_{S,α}* is an active weight portion movement amount required to attain the balance of the vehicle body against the inertial force due to the vehicle acceleration and the drive motor reactive torque, that is, the amount of movement for canceling the effects of the acceleration and deceleration of the vehicle 10.

λ_{S,V}* is the active weight portion movement amount required to attain the balance of the vehicle body against the air resistance torque acting on the vehicle body and the anti-torque that is the frictional resistance torque due to, for example, the viscous friction acting on the rotary shaft of the drive wheels 12, that is, the amount of movement for canceling the effect of the speed-dependent resistance. The first term of the numerator of the expression of λ_{S,V}* represents the magnitude of the frictional resistance torque due to, for example, the viscous friction acting on the rotary shaft of the drive wheels 12. The second term of the numerator of the expression of λ_{S,V}* represents the magnitude of the air resistance torque acting on the vehicle body (more strictly, the sum of the torque that is produced by the air resistance acting on the vehicle body so as to incline the vehicle body directly and the reactive torque that is the reaction to the drive torque added to cancel the effect of the air resistance).

In addition, D_{W} is the drive wheel frictional resistance coefficient of the drive wheel rotational angular speed, D₁ is the vehicle body air resistance coefficient of the drive wheel rotational angular speed, and h_{1,D} is the vehicle body air resistance center height (height from the road surface to the center of action of the air resistance), which are given predetermined constant values in advance.

(Expression 2)

The target value of the vehicle body inclination angle, θ₁*, is expressed by Formula 2 below.

$${θ}_{1}^{*} = \{ \begin{matrix}{θ}_{1 , α}^{*} + {θ}_{1 , V}^{*} + {θ}_{S , Max} & ( {λ}_{S , α}^{*} + {λ}_{S , V}^{*} \leq - {λ}_{S , Max} ) \\ 0 & ( - {λ}_{S , Max} < {λ}_{S , α}^{*} + {λ}_{S , V}^{*} < {λ}_{S , Max} ) \\ {θ}_{1 , α}^{*} + {θ}_{1 , V}^{*} - {θ}_{S , Max} & ( {λ}_{S , α}^{*} + {λ}_{S , V}^{*} \geq {λ}_{S , Max} )\end{matrix} \qquad Formula 2$$

In this formula,

$${θ}_{1 , α}^{*} = \frac{{m}_{1} {l}_{1} + \tilde{M} {R}_{W}}{{m}_{1} {l}_{1}} {α}^{*} , {θ}_{1 , V}^{*} = \frac{{D}_{W} {\dot{θ}}_{W}^{*} + {D}_{1} {h}_{1 , D} {\dot{θ}}_{W}^{* 2}}{{m}_{1} {gl}_{1}} , \\ and$$

$${θ}_{S , Max} = \frac{{m}_{S} {λ}_{S , Max}}{{m}_{1} {l}_{1}} .$$

θ_{S,Max} is a value obtained by converting, into a vehicle body inclination angle, the effect of moving the ride section 14, which functions as the active weight portion, to the active weight portion movement limit λ_{S,Max}, the value being the amount to be subtracted that corresponds to the amount of movement of the ride section 14.

Meanwhile, θ_{1,α}* is a vehicle body inclination angle required to attain the balance of the vehicle body against the inertial force due to the vehicle acceleration and the drive motor reactive torque, that is, the inclination angle for canceling the effects of the acceleration and deceleration of the vehicle 10.

On the other hand, θ_{1,V}* is the vehicle body inclination angle required to attain the balance of the vehicle body against the air resistance torque acting on the vehicle body and the anti-torque that is the frictional resistance torque due to, for example, the viscous friction acting on the rotary shaft of the drive wheels 12, that is, the inclination angle for canceling the effect of the speed-dependent resistance.

The main control ECU 21 subsequently calculates the remaining target values (step S3-2). That is, each target value is differentiated or integrated with respect to time to calculate respective target values of the drive wheel rotational angle, the vehicle body inclination angular speed, and the active weight portion movement speed.

In this embodiment, as described above, the target values of the vehicle body attitude, that is, the target value of the active weight portion position and the target value of the vehicle body inclination angle, are determined in consideration of not only the inertial force acting on the vehicle body due to the target value of the vehicle acceleration and the drive motor reactive torque but also the speed-dependent resistance, such as the air resistance acting on the vehicle body due to the target value of the drive wheel rotational angular speed (vehicle speed), and the drive motor reactive torque.

In this event, the center of gravity of the vehicle body is moved so as to cancel a torque acting on the vehicle body to incline the vehicle body, that is, a vehicle body inclination torque, using the action of the gravitational force. For example, when the vehicle 10 travels forward, the ride section 14 is moved forward, and further the vehicle body is inclined forward. On the other hand, when the vehicle 10 travels rearward, the ride section 14 is moved rearward, and further the vehicle body is inclined rearward.

In this embodiment, as shown in FIG. 8, the ride section 14 is first moved without inclining the vehicle body. When the ride section 14 reaches the active weight portion movement limit, the vehicle body starts being inclined. Therefore, the vehicle body is not inclined forward or rearward during small acceleration or deceleration or low speed travel, which provides the passenger 15 with improved ride comfort and suppresses sight shaking.

Note that although the target value of the drive wheel rotational angular speed is used as the drive wheel rotational angular speed for estimating the magnitude of the speed-dependent resistance in this embodiment, the actually measured value, that is, the actual value may be used. In addition, the slip ratio of the drive wheels 12 may be additionally considered in estimating the air resistance.

Although in this embodiment, it is assumed that the active weight portion movement limit is the same in both forward and rearward directions, whether to incline the vehicle body may be determined based on the respective limits when the active weight portion movement limit differs between the forward and rearward directions. For example, when the braking performance is set higher than the accelerating performance, it is necessary to set the active weight portion movement limit in the rearward direction farther than that in the forward direction.

In addition, although, in this embodiment, the vehicle body inclination torque is managed only by the movement of the ride section 14 when the acceleration and/or speed is low, part of or the entire vehicle body inclination torque may be managed by the inclination of the vehicle. Inclining the vehicle body can reduce a force in the front-rear direction acting on the passenger 15.

In this embodiment, formulas for the drive wheel frictional resistance torque are based on a linear model and formulas for the vehicle body air resistance are based on a model, in which the vehicle air resistance is proportional to the square of speed. However, formulas based on a more accurate non-linear model or a model with consideration of the viscous drag may also be used. In the case where non-linear formulas are used, functions may be applied in the form of a map.

Next, the actuator output determination process will be described.

FIG. 10 is a flowchart showing the procedures of an actuator output determination process according to the first embodiment of the present invention.

In the actuator output determination process, the main control ECU 21 first determines a feedforward output of each actuator (step S4-1). In this step, a feedforward output of the drive motors 52 is determined from each target value using Formula 3 below, and a feedforward output of the active weight portion motor 62 is determined using Formula 4 below.

(Expression 3)

The feedforward output of the drive motor 52, τ_{W,FF}, is expressed by Formula 3 below.

τ_{W,FF}=\tilde{M}R_{W}gα*+D_{W}\dot{θ}_{W}*+D₁R_{W}\dot{θ}_{W}*² Formula 3

\tilde{M}R_{W}gα* represents a drive torque required to achieve the target value α* of the vehicle acceleration, D_{W}\dot{θ}_{W}* represents the frictional resistance acting on the drive wheels 12, and D₁R_{W}\dot{θ}_{W}*² represents the torque for canceling the air resistance acting on the vehicle body.

By adding the drive torque so as to cancel the speed-dependent resistance that is estimated using the dynamic model, it is possible to perform the running and attitude control of the vehicle 10 with high precision and it is also possible to always give the passenger 15 similar manipulation feel. Specifically, even during high speed travel, the vehicle 10 can also accelerate and decelerate in the same way as during low speed travel in response to a specific manipulation operation of the joystick 31.

(Expression 4)

The feedforward output of the active weight portion motor 62, S_{S,FF}, is expressed by Formula 4 below.

S_{S,FF}=mₛgθ₁*+mₛgα* Formula 4

m_{S}gθ₁* represents a ride section thrust required to keep the ride section 14 at the target position according to the target value θ₁* of the vehicle body inclination angle, and m_{S}gα* represents the ride section thrust required to keep the ride section 14 at the target position according to the inertial force due to the target value α* of the vehicle acceleration.

In the embodiment, as described above, the feedforward outputs are provided theoretically to achieve control with higher precision.

Note that although the influence of the air resistance acting on the ride section 14 on the control of the position of the ride section 14 is not taken into consideration in this embodiment, this may also be taken into consideration. For example, a value obtained by multiplying the square of the drive wheel rotational angular speed by a predetermined coefficient that is set in advance based on the shape and the projected area of the ride section 14 may be added as the third term of the right hand side of Formula 4. In this way, it is possible to perform more precise attitude control.

The feedforward outputs may be omitted as necessary. In this case, values with a steady-state deviation and close to the feedforward outputs are indirectly provided by feedback control. It is possible to reduce the steady-state deviation by using an integral gain.

The main control ECU 21 subsequently determines a feedback output of each actuator (step S4-2). In this step, a feedback output of the drive motors 52 is determined from the deviation between each target value and the actual state quantity using Formula 5 below, and a feedback output of the active weight portion motor 62 is determined using Formula 6 below.

(Expression 5)

The feedback output of the drive motor 52, τ_{W,FB}, is expressed by Formula 5 below.

τ_{W,FB}=−K_{W1}(θ_{W}−θ_{W}*)−K_{W2}(\dot{θ}_{W}−\dot{θ}_{W}*)−K_{W3}(θ₁−θ₁*)−K_{W4}(\dot{θ}₁−\dot{θ}₁*)−K_{W5}(λ_{S}−λ_{S}*)−K_{W6}(\dot{λ}_{S}−\dot{λ}_{S}*) Formula 5

In this formula, K_{W1} to K_{W6} are feedback gains and the values of the optimal regulator are set as these values in advance, for example. Note that * means the target value.

The feedback output of the active weight portion motor 62, S_{S,FB}, is expressed by Formula 6 below.

S_{W,FB}=−K_{S1}(θ_{W}−θ_{W}*)−K_{S2}(\dot{θ}_{W}−\dot{θ}_{W}*)−K_{S3}(θ₁−θ₁*)−K_{S4}(\dot{θ}₁−\dot{θ}₁*)−K_{S5}(λ_{S}−λ_{S}*)−K_{S6}(\dot{λ}_{S}−\dot{λ}_{S}*) Formula 6

In this formula, K_{S1} to K_{S6} are feedback gains and the values of the optimal regulator are set as these values in advance, for example. Note that * means the target value.

Non-linear feedback control such as sliding mode control may also be introduced. Some of the feedback gains except K_{W2}, K_{W3}, and K_{S5} may be set to zero for simpler control. An integral gain may be introduced to eliminate the steady-state deviation.

The main control ECU 21 finally provides a command value to each element control system (step S4-3). In this step, the main control ECU 21 transmits the sum of the feedforward output and the feedback output determined as discussed above to the drive wheel control ECU 22 and the active weight portion control ECU 23 as a drive torque command value and an active weight portion thrust command value.

As described above, in this embodiment, the drive torque for the drive wheels 12 and the position of the center of gravity of the vehicle body are corrected based on the travel speed of the vehicle 10. Specifically, the drive torque is added to cancel the speed-dependent resistance torque and the ride section 14 is moved back and forth along the front-rear direction so that the air resistance torque acting on the vehicle body and the reactive torque that is the reaction to the added drive torque are canceled by the gravitational force torque produced by the movement of the center of gravity of the vehicle body. In this way, even during high speed travel, it is possible to control the running state and the attitude of the vehicle body with high precision, which makes it possible to further improve the drivability and the ride comfort.

Note that although the viscous friction acting on the drive wheels 12 and the air resistance acting on the vehicle body are taken into consideration as the speed-dependent resistance, other actions may be taken into consideration. When a component of the rolling friction of the drive wheels 12 that increases with the increase in speed or the air resistance acting on the drive wheels 12 is taken into consideration in a way similar to that, in which the viscous friction acting on the drive wheels 12 is take into consideration, for example, it is possible to perform more precise control.

Next, a second embodiment of the present invention will be described. Components having the same structure as those of the first embodiment are given the same reference numerals and description thereof is omitted. Description of the operation and the effect that are the same as those of the first embodiment is also omitted.

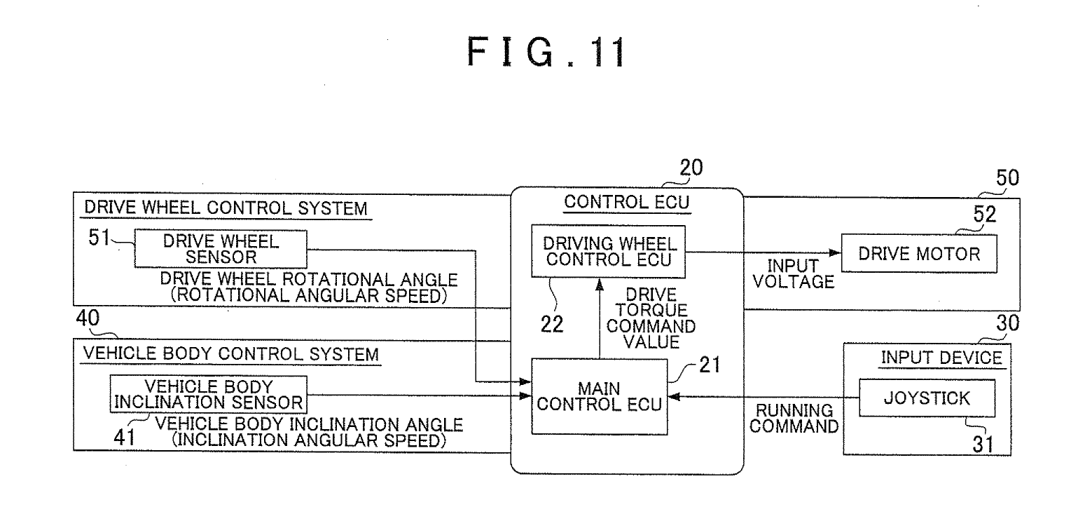

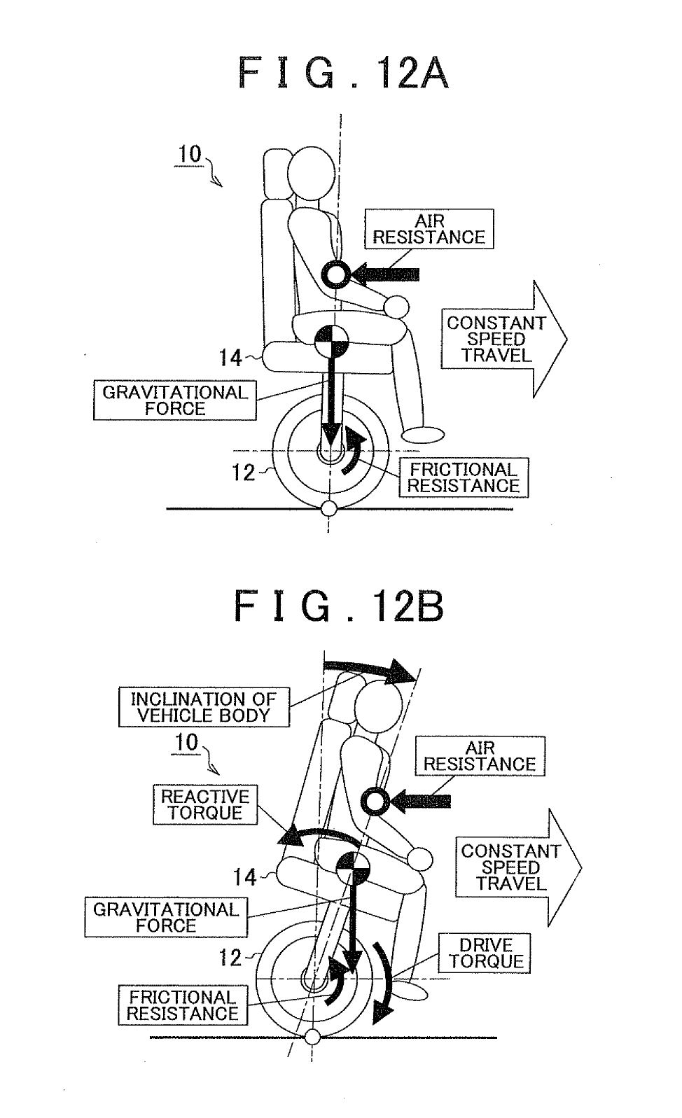

FIG. 11 is a block diagram showing a configuration of a control system for a vehicle according to a second embodiment of the present invention. FIG. 12 is a schematic diagram showing an operation of the vehicle according to the second embodiment of the present invention during high speed travel. FIG. 12A shows exemplary operation according to the related art for comparison. FIG. 12B shows operation according to this embodiment.

In the first embodiment, the ride section 14 is attached to the main body portion 11 so as to be relatively translatable with respect to the main body portion 11 in the front-rear direction of the vehicle 10, and functions as an active weight portion. In this case, the movement mechanism including the active weight portion motor 62 is provided to translate the ride section 14 and therefore, there is a possibility that the structure and the control system become complicated, expensive, heavy, etc. Needless to say, it is impossible to apply the first embodiment of the present invention to inverted-pendulum vehicles that have no movement mechanism for moving the ride section 14.

Thus, in this embodiment, the movement mechanism for moving the ride section 14 is omitted. In addition, as shown in FIG. 11, the active weight portion control system 60 is omitted, that is, the active weight portion control ECU 23, the active weight portion sensor 61, and the active weight portion motor 62 are omitted from the control system. Other components are the same in configuration as those in the first embodiment, and thus, description thereof is omitted.

In this embodiment, the drive torque for the drive wheels 12 and the inclination angle of the vehicle body are corrected based on the travel speed of the vehicle 10. Specifically, the drive torque is added to cancel the speed-dependent resistance torque (viscous drag torque) and the position of the center of gravity of the vehicle 10 is actively corrected by inclining the vehicle body in the advancing direction of the vehicle 10 as shown in FIG. 12B so that the viscous drag torque acting on the vehicle body and the reactive torque that is the reaction to the added drive torque are canceled by the gravitational force torque produced by the movement of the center of gravity of the vehicle body. In this way, even during high speed travel, it is possible to control the running state and the attitude of the vehicle body with high precision. As a result, it becomes possible to provide the inexpensive inverted-pendulum vehicle 10 that is better in drivability and ride comfort even during high speed travel.

On the other hand, in the case where the drive torque for the drive wheels 12 and the position of the center of gravity of the vehicle body are not corrected based on the travel speed as in the vehicles according to the related art described in the BACKGROUND ART section, in contrast, the error in the control of the travel speed and the attitude of the vehicle body increases with the increase in the travel speed. In other words, in the case of the inverted-pendulum vehicles, as shown in FIG. 12A, when the vehicle speed increases, the speed-dependent resistance, that is, the air resistance acting on the vehicle 10 and the resistance, such as the viscous friction acting on the rotary shaft of the drive wheels 12, also increase and the influence thereof on the running and attitude control increases.

Specifically, there is a possibility that the vehicle speed becomes lower than the target value because of the speed-dependent resistance. In addition, there is a possibility that the vehicle body is inclined rearward due to the air resistance torque acting on the vehicle body and the reactive torque acting on the vehicle body when the drive torque for canceling the speed-dependent resistance is added. As a result, the drivability and the ride comfort, which are important in terms of the mobility, are degraded.

In this embodiment, thus, the running and attitude control process is executed to correct the drive torque for the drive wheels 12 and the inclination angle of the vehicle body based on the travel speed of the vehicle 10, so that the vehicle 10 can stably stop and run even when the travel speed of the vehicle 10 increases.

Next, the running and attitude control process according to this embodiment will be described in detail. The outline of the running and attitude control process and the target running state determination process are similar to those of the first embodiment, and thus, the description thereof is omitted. Only the procedures of the state quantity acquisition process, the target vehicle body attitude determination process, and the actuator output determination process are described. The state quantity acquisition process is first described.

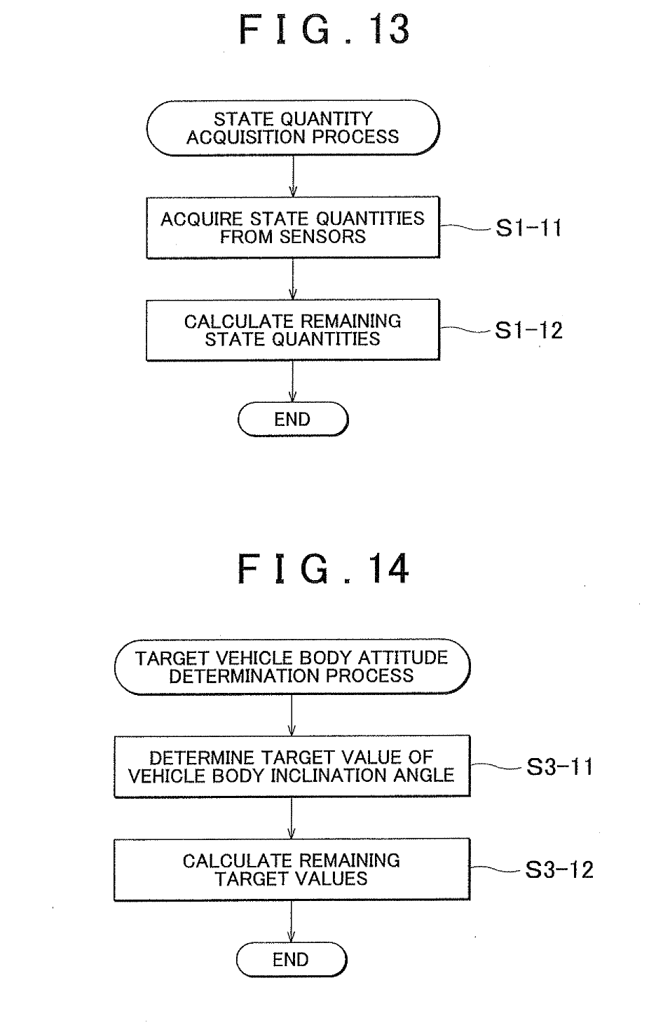

FIG. 13 is a flowchart showing the procedures of the state quantity acquisition process according to the second embodiment of the present invention.

In the state quantity acquisition process, the main ECU 21 first acquires state quantities from the sensors (step S1-11). In this step, the drive wheel rotational angle θ_{W} and/or the rotational angular speed \dot{θ}_{W} is/are acquired from the drive wheel sensor 51, and the vehicle body inclination angle θ₁ and/or the inclination angular speed \dot{θ}₁ is/are acquired from the vehicle body inclination sensor 41.

The main ECU 21 subsequently calculates the remaining state quantities (step S1-12). In this step, the remaining state quantities are calculated by differentiating or integrating the acquired state quantities with respect to time. When the acquired state quantities are the drive wheel rotational angle θ_{W} and the vehicle body inclination angle θ₁, for example, by differentiating these state quantities with respect to time, the rotational angular speed \dot{θ}_{W} and the inclination angular speed \dot{θ}₁ are obtained. When the acquired state quantities are the rotational angular speed \dot{θ}_{W} and the inclination angular speed \dot{θ}₁, for example, by integrating these state quantities with respect to time, the drive wheel rotational angle θ_{W} and the vehicle body inclination angle θ₁ are obtained.

Next, the target vehicle body attitude determination process will be described.

FIG. 14 is a flowchart showing the procedures of the target vehicle body attitude determination process according to the second embodiment of the present invention.

In the target vehicle body attitude determination process, the main control ECU 21 first determines a target value of the vehicle body inclination angle (step S3-11). In this step, the target value of the vehicle body inclination angle is determined, using Formula 7 below, based on the target value of the vehicle acceleration and the target value of the drive wheel rotational angular speed determined in the target running state determination process.

(Expression 6)

The target value of the vehicle body inclination angle, θ₁*, is expressed by Formula 7 below.

θ₁*=θ_{1,α}*+θ_{1,y}* Formula 7

In this formula,

$${θ}_{1 , α}^{*} = \frac{{m}_{1} {l}_{1} + \tilde{M} {R}_{W}}{{m}_{1} {l}_{1}} {α}^{*} and {θ}_{1 , V}^{*} = \frac{{D}_{W} {\dot{θ}}_{W}^{*} + {D}_{1} {h}_{1 , D} {\dot{θ}}_{W}^{* 2}}{{m}_{1} {gl}_{1}} .$$

Meanwhile, θ_{1,α}* is a vehicle body inclination angle required to attain the balance of the vehicle body against the inertial force due to the vehicle acceleration and the drive motor reactive torque, that is, the inclination angle for canceling the effects of the acceleration and deceleration of the vehicle 10.

On the other hand, θ_{1,V}* is the vehicle body inclination angle required to attain the balance of the vehicle body against the air resistance torque acting on the vehicle body and the anti-torque that is the frictional resistance torque due to, for example, the viscous friction acting on the rotary shaft of the drive wheels 12, that is, the inclination angle for canceling the effect of the speed-dependent resistance.

The main control ECU 21 subsequently calculates the remaining target values (step S3-12). That is, each target value is differentiated or integrated with respect to time to calculate respective target values of the drive wheel rotational angle and the vehicle body inclination angular speed.

In this embodiment, as described above, the target value of the vehicle body inclination angle is determined in consideration of not only the inertial force acting on the vehicle body due to the target value of the vehicle acceleration and the drive motor reactive torque but also the speed-dependent resistance, such as the air resistance acting on the vehicle body due to the target value of the drive wheel rotational angular speed (vehicle speed), and the drive motor reactive torque.

In this event, the center of gravity of the vehicle body is moved so as to cancel a torque acting on the vehicle body to incline the vehicle body, that is, a vehicle body inclination torque, using the action of the gravitational force. For example, when the vehicle 10 travels forward, the vehicle body is further inclined forward. When the vehicle 10 travels rearward, the vehicle body is further inclined rearward.

In this embodiment, formulas for the drive wheel frictional resistance torque are based on a linear model and formulas for the vehicle body air resistance are based on a model, in which the vehicle air resistance is proportional to the square of speed. However, formulas based on a more accurate non-linear model or a model with consideration of the viscous drag may also be used. In the case where non-linear formulas are used, functions may be applied in the form of a map.

Next, the actuator output determination process will be described.

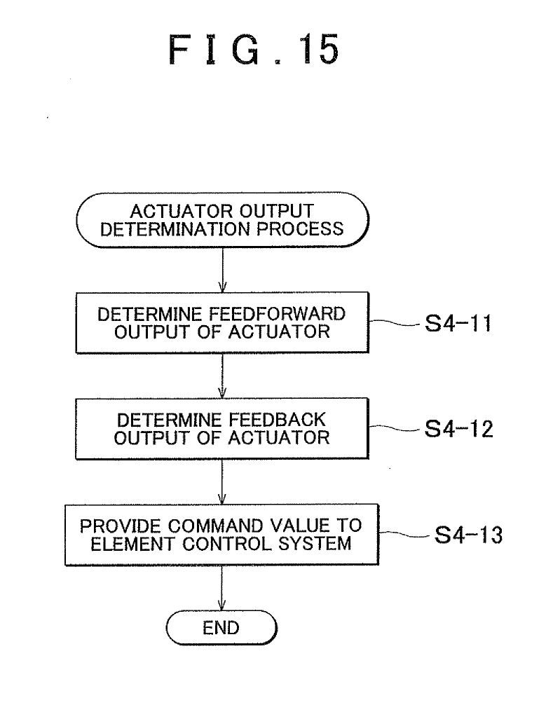

FIG. 15 is a flowchart showing the procedures of the actuator output determination process according to the second embodiment of the present invention.

In the actuator output determination process, the main control ECU 21 first determines a feedforward output of the actuator (step S4-11). In this step, a feedforward output of the drive motor 52 is determined from each target value using Formula 3 explained in the above description of the first embodiment.

By adding the drive torque so as to cancel the speed-dependent resistance that is estimated using the dynamic model as shown by the above Formula 3, it is possible to perform the running and attitude control of the vehicle 10 with high precision and it is also possible to always give the passenger 15 similar manipulation feel. Specifically, even during high speed travel, the vehicle 10 can also accelerate and decelerate in the same way as during low speed travel in response to a specific manipulation operation of the joystick 31.

The main control ECU 21 subsequently determines a feedback output of the actuator (step S4-12). In this step, a feedback output of the drive motors 52 is determined from the deviation between each target value and the actual state quantity using Formula 8 below.

(Expression 7)

The feedback output of the drive motor 52, τ_{W,FB}, is expressed by Formula 8 below.

τ_{W,FB}=−K_{W1}(θ_{W}−θ_{W}*)−K_{W2}(\dot{θ}_{W}−\dot{θ}_{W}*)−K_{W3}(θ₁−θ₁*)−K_{W4}(\dot{θ}₁−\dot{θ}₁*) Formula 8

In this formula, K_{W1} to K_{W4} are feedback gains and the values of the optimal regulator are set as these values in advance, for example. Note that * means the target value.

Non-linear feedback control such as sliding mode control may also be introduced. Some of the feedback gains except K_{W2} and K_{W3} may be set to zero for simpler control. An integral gain may be introduced to eliminate the steady-state deviation.

The main control ECU 21 finally provides a command value to the element control system (step S4-13). In this step, the main control ECU 21 transmits the sum of the feedforward output and the feedback output determined as discussed above to the drive wheel control ECU 22 as a drive torque command value.

As described above, in this embodiment, the drive torque for the drive wheels 12 and the position of the center of gravity of the vehicle body are corrected based on the travel speed of the vehicle 10. Specifically, the drive torque is added to cancel the speed-dependent resistance torque and the vehicle body is inclined forward so that the air resistance torque acting on the vehicle body and the reactive torque that is the reaction to the added drive torque are canceled by the gravitational force torque produced by the movement of the center of gravity of the vehicle body. Thus, it is possible to apply the second embodiment of the present invention to inverted-pendulum vehicles that have no movement mechanism for moving the ride section 14. In addition, it is possible to simplify the structure and the control system and it is therefore possible to obtain inexpensive and light-weight inverted-pendulum vehicles.

Next, a third embodiment of the present invention will be described. Components having the same structure as those of the first and second embodiments are given the same reference numerals and description thereof is omitted. Description of the operation and the effect that are the same as those of the first and second embodiments is also omitted.

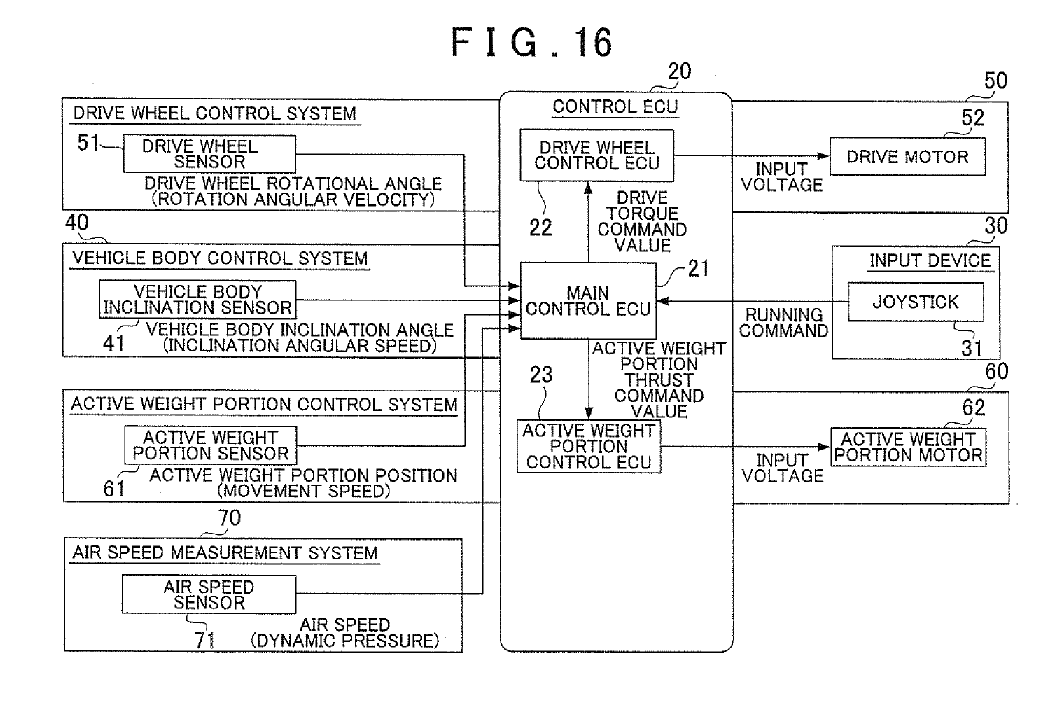

FIG. 16 is a block diagram showing a configuration of a control system for a vehicle according to a third embodiment of the present invention.

In this embodiment, air speed is measured and the vehicle 10 is controlled based on the measurement value.

If the air resistance is estimated based on the drive wheel rotational angular speed, a large error can occur in the estimated value of the air resistance when the drive wheels 12 spin. In general, when the vehicle speed that is estimated based on the rotational speed of the drive wheels 12, the air resistance is overestimated. This is because the air resistance is proportional to the square of the speed, which results in a significantly large error. In addition, because the drive torque is increased based on the erroneously estimated value of the air resistance, there is a possibility that the state of spinning of the drive wheels 12 is further intensified. In addition, because the center of gravity of the vehicle body is moved so as to attain the balance with the erroneously estimated value of the air resistance, there is a possibility that the vehicle body is significantly inclined. Also when the drive wheels 12 lock and slip on the road surface, similar problems can occur.

When the wind becomes strong, the error in the control of the travel speed and the vehicle attitude becomes large. This is because the large air resistance accompanying the strong wind affects the running and attitude control of the vehicle 10. As a result, the drivability and the ride comfort are degraded in terms of the mobility. In general, the travel speed of the inverted-pendulum vehicles is low and therefore, the influence of the wind is relatively large.

In this embodiment, the drive torque for the drive wheels 12 and the position of the ride section 14 are corrected based on the rotational speed of the drive wheels 12 and the air speed of the vehicle 10. Specifically, the viscous friction acting on the drive wheels 12 is estimated based on the drive wheel rotational angular speed, and the air resistance acting on the vehicle body is estimated based on the air speed measured by an air speed indicator.

In this way, even when the drive wheels 12 spin, for example, the running state and the vehicle body attitude are controlled with high precision, so that it is possible to provide the inverted-pendulum vehicle 10 that is better in drivability and ride comfort. In addition, also when the wind is strong, the running state and the vehicle body attitude are controlled with high precision, so that it is possible to provide the inverted-pendulum vehicle 10 that is better in drivability and ride comfort.

Thus, as shown in FIG. 16, the vehicle 10 has an air speed sensor 71, which functions as an air speed measurement means. A measurement device using a Pitot tube that measures the dynamic pressure is used as the air speed sensor 71, for example. However, the air speed sensor 71 may be any type of sensor as long as it can measure the air speed.

The vehicle 10 also has an air speed measurement system 70 including the air speed sensor 71. The air speed sensor 71 measures the air speed that is the speed of the vehicle 10 relative to the air, and sends the measured value to the main control ECU 21.

Next, the running and attitude control process according to this embodiment will be described in detail. The outline of the running and attitude control process and the target running state determination process are similar to those of the first embodiment, and thus, the description thereof is omitted. Only the procedures of the state quantity acquisition process, the target vehicle body attitude determination process, and the actuator output determination are described. The state quantity acquisition process is first described.

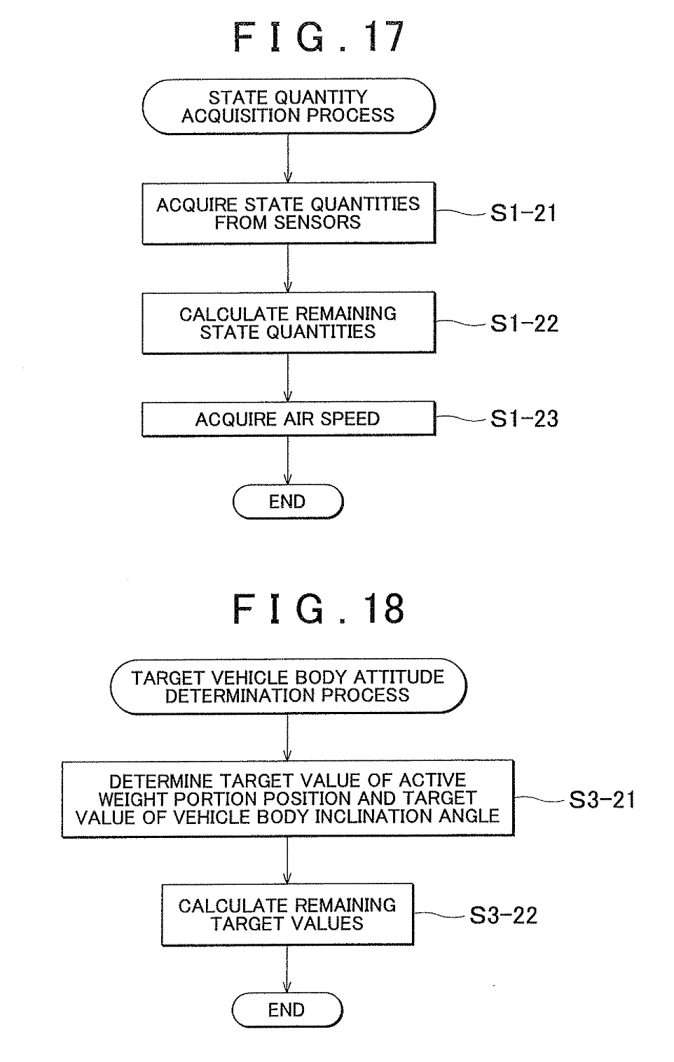

FIG. 17 is a flowchart showing the procedures of the state quantity acquisition process according to the third embodiment of the present invention.

In the state quantity acquisition process, the main ECU 21 first acquires state quantities from the sensors (step S1-21). In this step, the drive wheel rotational angle θ_{W} and/or the rotational angular speed \dot{θ}_{W} is/are acquired from the drive wheel sensor 51, the vehicle body inclination angle θ₁ and/or the inclination angular speed \dot{θ}₁ is/are acquired from the vehicle body inclination sensor 41, and the active weight portion position λ_{S} and/or the movement speed \dot{λ}_{S} is/are acquired from the active weight portion sensor 61.

The main ECU 21 subsequently calculates the remaining state quantities (step S1-22). In this step, the remaining state quantities are calculated by differentiating or integrating the acquired state quantities with respect to time. When the acquired state quantities are the drive wheel rotational angle θ_{W}, the vehicle body inclination angle θ₁, and the active weight portion position λ_{S}, for example, by differentiating these state quantities with respect to time, the rotational angular speed \dot{θ}_{W}, the inclination angular speed \dot{θ}₁, and the movement speed \dot{λ}_{S} are obtained. When the acquired state quantities are the rotational angular speed \dot{θ}_{W}, the inclination angular speed \dot{θ}₁, and the movement speed \dot{λ}_{S}, for example, by integrating these state quantities with respect to time, the drive wheel rotational angle θ_{W}, the vehicle body inclination angle θ₁, and the active weight portion position λ_{S} are obtained.

The main control ECU 21 subsequently acquires an air speed (step S1-23). In this step, the air speed measured by the air speed sensor 71 is acquired.

Next, the target vehicle body attitude determination process will be described.

FIG. 18 is a flowchart showing the procedures of the target vehicle body attitude determination process according to the third embodiment of the present invention.

In the target vehicle body attitude determination process, the main control ECU 21 first determines a target value of the active weight portion position and a target value of the vehicle body inclination angle (step S3-21). In this step, the target value of the active weight portion position and the target value of the vehicle body inclination angle are determined, using Formula 1 and Formula 2 explained in the description of the first embodiment, based on the target value of the vehicle acceleration and the target value of the drive wheel rotational angular speed determined in the target running state determination process, and the air speed measured by the air speed sensor 71.

$$In this embodiment , {λ}_{S , V}^{*} = \frac{{D}_{W} {\dot{θ}}_{W}^{*} + {\tilde{D}}_{1} {h}_{1 , D} {V}_{r}^{2}}{{m}_{S} g} . \\ In addition , {θ}_{1 , V}^{*} = \frac{{D}_{w} {\dot{θ}}_{W}^{*} + {\tilde{D}}_{1} {h}_{1 , D} {V}_{r}^{2}}{{m}_{1} {gl}_{1}} . \qquad ( Expression 8 )$$

In this expression, Vᵣ represents the air speed (m/s), and \tilde{D}₁=D₁/R_{W}².

The main control ECU 21 subsequently calculates the remaining target values (step S3-22). That is, each target value is differentiated or integrated with respect to time to calculate respective target values of the drive wheel rotational angle, the vehicle body inclination angular speed, and the active weight portion movement speed.

In this embodiment, as described above, the target values of the vehicle body attitude, that is, the target value of the active weight portion position and the target value of the vehicle body inclination angle, are determined in consideration of not only the inertial force acting on the vehicle body due to the target value of the vehicle acceleration and the drive motor reactive torque but also the speed-dependent resistance, such as the air resistance acting on the vehicle body due to the target value of the drive wheel rotational angular speed (vehicle speed), and the drive motor reactive torque.

In this event, the center of gravity of the vehicle body is moved so as to cancel a torque acting on the vehicle body to incline the vehicle body, that is, a vehicle body inclination torque, using the action of the gravitational force. For example, when the vehicle 10 travels forward or there is a head wind, the ride section 14 is moved forward, and further the vehicle body is inclined forward. On the other hand, when the vehicle 10 travels rearward or there is a tailwind, the ride section 14 is moved rearward, and further the vehicle body is inclined rearward.

In this embodiment, as shown in FIG. 8 explained in the description of the first embodiment, the ride section 14 is first moved without inclining the vehicle body, and when the ride section 14 reaches the active weight portion movement limit, the vehicle body starts being inclined. Therefore, the vehicle body is not inclined forward or rearward during low speed travel or weak wind conditions, which provides the passenger 15 with improved ride comfort and suppresses sight shaking.

Note that although the target value of the drive wheel rotational angular speed is used as the drive wheel rotational angular speed for estimating the viscous friction acting on the drive wheels 12 in this embodiment, the actually measured value, that is, the actual value may be used.

Although in this embodiment, it is assumed that the active weight portion movement limit is the same in both forward and rearward directions, whether to incline the vehicle body may be determined based on the respective limits when the active weight portion movement limit differs between the forward and rearward directions. For example, when the braking performance is set higher than the accelerating performance, it is necessary to set the active weight portion movement limit in the rearward direction farther than that in the forward direction.

In addition, although, in this embodiment, the vehicle body inclination torque is managed only by the movement of the ride section 14 when the acceleration and/or speed of the vehicle 10 is low or the wind is weak, part of or the entire vehicle body inclination torque may be managed by the inclination of the vehicle. Inclining the vehicle body can reduce a force in the front-rear direction acting on the passenger 15.

In this embodiment, formulas for the drive wheel frictional resistance torque are based on a linear model and formulas for the vehicle body air resistance are based on a model, in which the vehicle air resistance is proportional to the square of speed. However, formulas based on a more accurate non-linear model or a model with consideration of the viscous drag may also be used. In the case where non-linear formulas are used, functions may be applied in the form of a map.

Next, the actuator output determination process will be described.

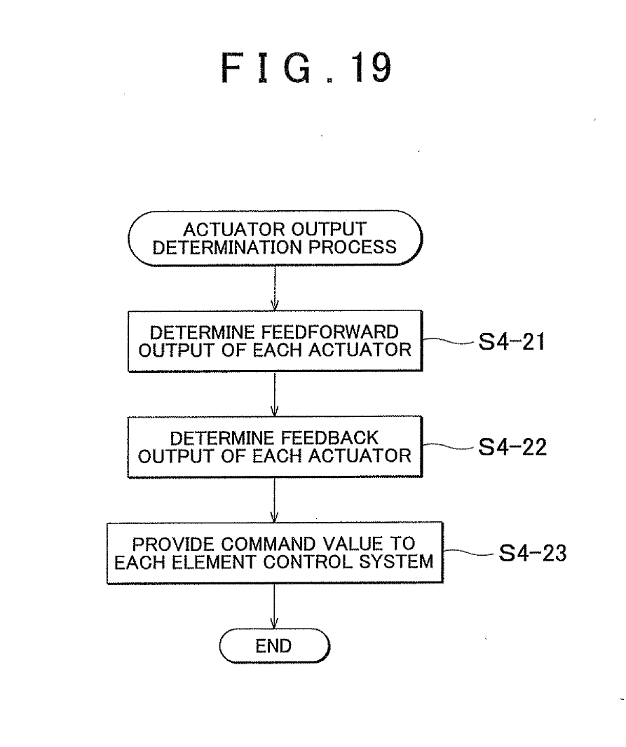

FIG. 19 is a flowchart showing the procedures of the actuator output determination process according to the third embodiment of the present invention.

In the actuator output determination process, the main control ECU 21 first determines a feedforward output of each actuator (step S4-21). In this step, a feedforward output of the drive motors 52 is determined from each target value and the air speed using Formula 9 below, and a feedforward output of the active weight portion motor 62 is determined using Formula 4 explained in the description of the first embodiment.

(Expression 9)

The feedforward output of the drive motor 52, τ_{W,FF}, is expressed by Formula 9 below.

τ_{W,FF}=\tilde{M}R_{W}gα*+D_{W}\dot{θ}_{W}*+\tilde{D}₁R_{W}Vᵣ² Formula 9

\tilde{M}R_{W}gα* represents a drive torque required to achieve the target value α* of the vehicle acceleration, D_{W}\dot{θ}_{W}* represents the frictional resistance acting on the drive wheels 12, and \tilde{D}₁R_{W}Vᵣ² represents the torque for canceling the air resistance acting on the vehicle body.

By adding the drive torque so as to cancel the speed-dependent resistance torque that is estimated using the dynamic model, it is possible to perform the running and attitude control of the vehicle 10 with high precision and it is also possible to always give the passenger 15 similar manipulation feel. Specifically, even during high speed travel or strong wind conditions, the vehicle 10 can also accelerate and decelerate in the same way as during low speed travel in response to a specific manipulation operation of the joystick 31.

The main control ECU 21 subsequently determines a feedback output of each actuator (step S4-22). In this step, a feedback output of the drive motors 52 is determined from the deviation between each target value and the actual state quantity using Formula 5 explained in the description of the first embodiment, and a feedback output of the active weight portion motor 62 is determined using Formula 6 explained in the description of the first embodiment.

Non-linear feedback control such as sliding mode control may also be introduced. Some of the feedback gains except K_{W2}, K_{W3}, and K_{S5} may be set to zero for simpler control. An integral gain may be introduced to eliminate the steady-state deviation.

The main control ECU 21 finally provides a command value to each element control system (step S4-23). In this step, the main control ECU 21 transmits the sum of the feedforward output and the feedback output determined as discussed above to the drive wheel control ECU 22 and the active weight portion control ECU 23 as a drive torque command value and an active weight portion thrust command value.

As described above, in this embodiment, the drive torque for the drive wheels 12 and the position of the ride section 14 are corrected based on the rotational speed of the drive wheels 12 and the air speed of the vehicle 10. Specifically, the frictional resistance torque acting on the drive wheels 12 is estimated based on the drive wheel rotational angular speed, and the air resistance acting on the vehicle body is estimated based on the air speed measured by the air speed indicator.

In this way, even when the drive wheels 12 are spinning or slipping, the running state and the vehicle body attitude are controlled with high precision, so that it is possible to provide the inverted-pendulum vehicle 10 that is better in drivability and ride comfort. In addition, also when the wind is strong, the running state and the vehicle body attitude are controlled with high precision, so that it is possible to provide the inverted-pendulum vehicle 10 that is better in drivability and ride comfort.

Although in the description of this embodiment, an example is described, in which the air resistance is estimated based on the air speed acquired from the air speed sensor 71, the air resistance may be estimated by directly acquiring the dynamic pressure value when a dynamic pressure-measuring sensor, such as a Pitot pipe, is used as the air speed sensor 71. This makes it possible to correctly take into consideration the influence caused by the change in the density of the air.

Next, a fourth embodiment of the present invention will be described. Components having the same structure as those of the first to third embodiments are given the same reference numerals and description thereof is omitted. Description of the operation and the effect that are the same as those of the first to third embodiments is also omitted.

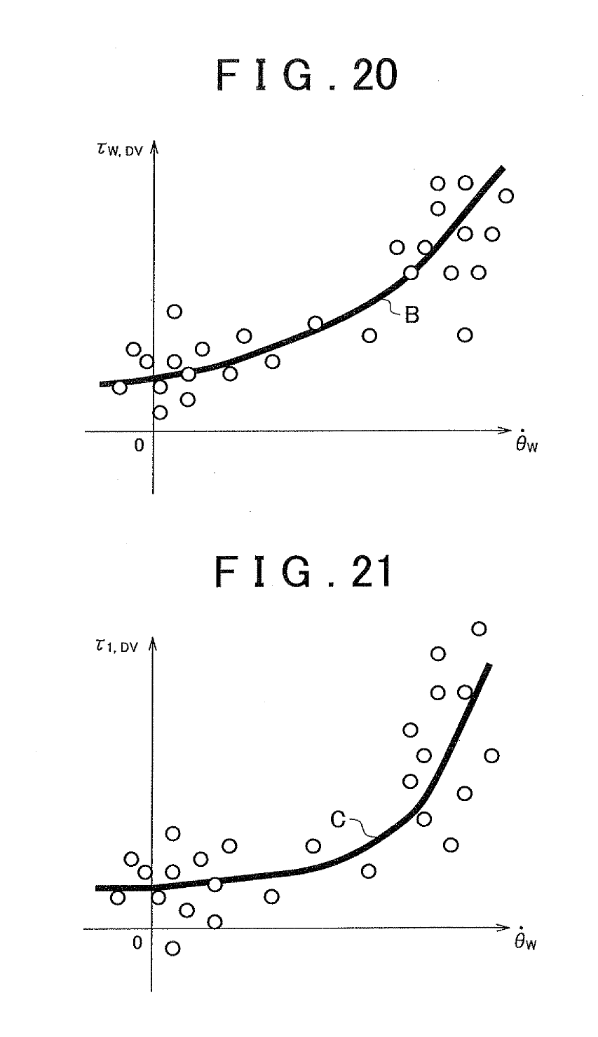

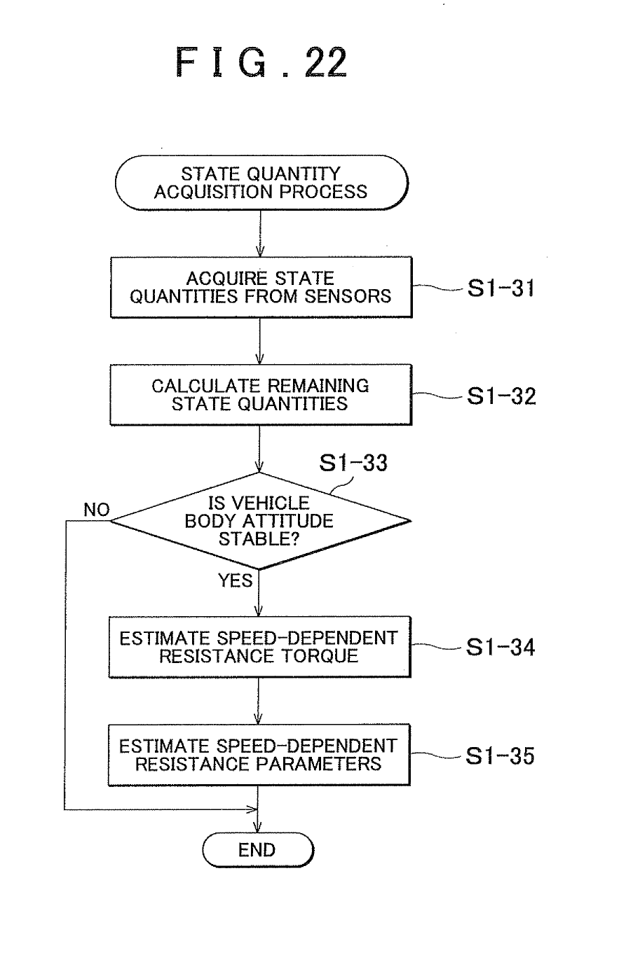

FIG. 20 is a diagram showing the estimation of parameters of the drive wheel speed-dependent resistance torque according to the fourth embodiment of the present invention. FIG. 21 is a diagram showing the estimation of parameters of the vehicle body speed-dependent resistance torque according to the fourth embodiment of the present invention. FIG. 22 is a flowchart showing the procedures of the state quantity acquisition process according to the fourth embodiment of the present invention.

In this embodiment, the parameters of the speed-dependent resistance are estimated based on the time histories of the running state, the vehicle body attitude, etc.

The parameters of the speed-dependent resistance vary depending on the use state and the use history of the vehicle 10. For example, the drive wheel frictional resistance coefficient is apt to change with time. The vehicle body air resistance coefficient and the height of the center of action vary depending on the shape of the load or the passenger 15 on the ride section 14. When there is an error in the parameters of the speed-dependent resistance, there is a possibility that the running and attitude control is not appropriately performed. Depending on the use state and/or the use history, the drivability and the ride comfort can be degraded.

Thus, in this embodiment, the parameters of the speed-dependent resistance are estimated based on the measured running state, the vehicle body attitude, and the actuator output. Specifically, the parameters are estimated based on the time history of the relation between the various drive wheel rotational angular speeds and the speed-dependent resistance torques. The data taken while the speed of change of the vehicle body attitude is low only are used for estimation. The estimated values for the low vehicle speed state are used as the offset values of the speed-dependent resistance torque for correction of the error.

Thus, it is possible to accurately estimate the value of the speed-dependent resistance acting on the vehicle 10 irrespective of the use state and/or the use history of the vehicle 10. Thus, it is possible to provide the inverted-pendulum vehicle 10 that is better in drivability and ride comfort.

Next, the running and attitude control process according to this embodiment will be described in detail. The outline of the running and attitude control process and the target running state determination process, the target vehicle body attitude determination process, and the actuator output determination process are similar to those of the first embodiment, and thus, the description thereof is omitted. Only the procedures of the state quantity acquisition process are described.

In the state quantity acquisition process, the main ECU 21 first acquires state quantities from the sensors (step S1-31). In this step, the drive wheel rotational angle θ_{W} and/or the rotational angular speed \dot{θ}_{E} is/are acquired from the drive wheel sensor 51, the vehicle body inclination angle θ₁ and/or the inclination angular speed \dot{θ}₁ is/are acquired from the vehicle body inclination sensor 41, and the active weight portion position λ_{S} and/or the movement speed \dot{λ}_{S} is/are acquired from the active weight portion sensor 61.

The main ECU 21 subsequently calculates the remaining state quantities (step S1-32). In this step, the remaining state quantities are calculated by differentiating or integrating the acquired state quantities with respect to time. When the acquired state quantities are the drive wheel rotational angle θ_{S}, the vehicle body inclination angle θ₁, and the active weight portion position λ_{S}, for example, by differentiating these state quantities with respect to time, the rotational angular speed \dot{θ}_{W}, the inclination angular speed \dot{θ}₁, and the movement speed \dot{λ}_{S} are obtained. When the acquired state quantities are the rotational angular speed \dot{θ}_{W}, the inclination angular speed \dot{θ}₁, and the movement speed \dot{λ}_{S}, for example, by integrating these state quantities with respect to time, the drive wheel rotational angle θ_{W}, the vehicle body inclination angle θ₁, and the active weight portion position λ_{S} are obtained.

The main control ECU 21 subsequently determines whether the vehicle body attitude is stable (step S1-33). In this step, when all the absolute values of the vehicle body inclination angular speed, the vehicle body inclination angular acceleration, the active weight portion movement speed, and the active weight portion movement acceleration are equal to or lower than respective predetermined thresholds, it is determined that the vehicle body attitude is stable, that is, the influence of the change of the vehicle body attitude is small.

The data taken while the vehicle body attitude is changing are not used in estimating the parameters of the speed-dependent resistance in this embodiment. Specifically, when any one of the absolute values of the vehicle body inclination angular speed, the vehicle body inclination angular acceleration, the active weight portion movement speed, and the active weight portion movement acceleration is greater than the corresponding one of the threshold values that are respectively set in advance, it is determined that the influence of the change of the vehicle body attitude on the estimated values of the parameters is large and the estimated values of the parameters of the speed-dependent resistance are not updated. In addition, data taken under such conditions are not reflected on the following estimated values of the parameters of the speed-dependent resistance.

Thus, when the vehicle body attitude is rapidly changing, the parameters of the speed-dependent resistance are not estimated. This is because it is considered that the possibility that the parameters of the speed-dependent resistance rapidly vary in a short period of time is very low and it is unnecessary to perform the estimation when the vehicle body attitude is rapidly changing.

By actively excluding the case where accurate estimation is difficult and a large error is therefore expected, it is possible to easily perform accurate estimation.

Note that although, in this embodiment, the data taken while the vehicle body attitude is changing are not used in estimating the parameters of the speed-dependent resistance, the use of data may be inhibited based on other factors. For example, the use of the data taken during running on a slope, the data taken during ascending or descending a step, the data taken during rapid acceleration or deceleration, the data taken while the vehicle is stopped, the data taken while the passenger is getting on or getting off the vehicle, the data taken while an abnormality is occurring in the system, etc. may be inhibited. However, when an estimation model, with which it is possible to take these factors into consideration sufficiently accurately, the parameters of the speed-dependent resistance may be estimated with these factors taken into consideration.

When it is determined that the vehicle body attitude is stable, the main control ECU 21 estimates the speed-dependent resistance torque (step S1-34). In this step, the drive wheel speed-dependent resistance torque and the vehicle body speed-dependent resistance torque are estimated using Formula 10 and Formula 11 below, respectively, based on the quantities of state, and the output of each actuator determined in the actuator output determination process in the preceding (one step before in terms of time) running and attitude control process.

(Expression 10)

The drive wheel speed-dependent resistance torque, τ_{W,DV}, is expressed by Formula 10 below.

τ_{W,DV}=\tilde{τ}_{W,D}−τ_{W,D0}⁽ⁿ⁾ Formula 10

\tilde{τ}_{W,D} represents the estimated value of the drive wheel speed-dependent resistance torque, and \tilde{τ}_{W,D}=τ_{W}−\tilde{M}gR_{W}α. α is the actual acceleration of the vehicle 10 and is obtained from the equation, α=R_{W}\ddot{θ}_{W}. τ_{W,D0}⁽ⁿ⁾ is the offset value for the estimated value of the drive wheel speed-dependent resistance torque and is obtained from the equation, τ_{W,D0}⁽ⁿ⁾=ζ_{W}\tilde{τ}_{W,D}+(1−ζ_{W})τ_{W,D0}⁽ⁿ⁻¹⁾. ζ_{W} represents the filter coefficient, and

$${ζ}_{W} = \{ \begin{matrix}{ζ}_{T} & ( \vert {\dot{θ}}_{W} \vert < {\dot{θ}}_{W , sh , W} ) \\ 0 & ( \vert {\dot{θ}}_{W} \vert \geq {\dot{θ}}_{W , sh , W} ) .\end{matrix}$$

In addition,

$${ζ}_{W} = \frac{1}{1 + {T}_{W} / Δ t} .$$

T_{W} and Δt represent the time constant of the filter and the intervals of data acquisition, and \tilde{θ}_{W,sh,W} represents the invalidation threshold value of the drive wheel speed-dependent resistance torque, which are given predetermined values in advance.

(Expression 11)

The vehicle body speed-dependent resistance torque, τ_{1,DV}, is expressed by Formula 11 below.

τ_{1,DV}=\tilde{τ}_{1,D}−τ_{1,D0}⁽ⁿ⁾ Formula 11

\tilde{τ}_{1,D} represents the estimated value of the vehicle body speed-dependent resistance torque, and \tilde{τ}_{1,D}=−τ_{W}+m₁gl₁(θ₁−α)+m_{S}gλ_{S}. τ_{1,D0}⁽ⁿ⁾ is the offset value for the estimated value of the vehicle body speed-dependent resistance torque and is obtained from the equation, τ_{1,D0}⁽ⁿ⁾=ζ₁\tilde{τ}_{1,D}+(1−ζ₁)τ_{1,D0}⁽ⁿ⁻¹⁾. ζ₁ represents the filter coefficient, and

$${ζ}_{1} = \{ \begin{matrix}{ζ}_{T} & ( \vert {\dot{θ}}_{W} \vert < {\dot{θ}}_{W , sh , 1} ) \\ 0 & ( \vert {\dot{θ}}_{W} \vert \geq {\dot{θ}}_{W , sh , 1} ) .\end{matrix}$$

\dot{θ}_{W,sh,1} represents the invalidation threshold value of the vehicle body speed-dependent resistance torque, which is given a predetermined value in advance.

As described above, in this embodiment, the speed-dependent resistance torque is estimated based on the running state, the vehicle body attitude, and the value of the drive torque of the vehicle 10. In other words, the viscous drag torque component that depends on the vehicle speed is extracted from the torque acting on the drive wheels 12 and the vehicle body. Specifically, the viscous drag torque component is extracted by removing, from the drive torque, the other torque components that are conceivable from the theoretical dynamic model, based on the measurement values of the drive wheel rotational angular speed, the vehicle body inclination angle, and the active weight portion position. In this embodiment, the value obtained by subtracting the component due to the inertial force of the vehicle 10 from the drive torque acting on the drive wheels 12 is defined as the drive wheel speed-dependent resistance torque. In addition, the value obtained by subtracting the gravitational force torque produced by the vehicle body inclination, the torque due to the inertial force caused by the acceleration of the vehicle 10, and the gravitational force torque produced by the shift of the position of the ride section 14 from the reactive torque acting on the vehicle body that is the reaction to the drive torque is defined as the vehicle body speed-dependent resistance torque.

In addition, the component unrelated to the vehicle speed is subtracted from each of the estimated values of the speed-dependent resistance torques. Specifically, the values of the speed-dependent resistance torques estimated when the drive wheel rotational angular speed is lower than a predetermined threshold is regarded as the component unrelated to the vehicle speed. Then, the estimated values that satisfy this condition are selectively extracted, the value obtained by subjecting each of these estimated values to a low pass filter defined by a predetermined time constant is regarded as the offset values (constant components) of the estimated values of the speed-dependent resistance torques, and these offset components are subtracted from the estimated values that are obtained sequentially, whereby the estimated values of the speed-dependent resistance torques are corrected. These components correspond to other components (deviation of the center of gravity of the vehicle body, the road surface gradient, the static friction, etc., for example) that are not taken into consideration in the dynamic model, and by removing such components to the extent possible, it is possible to improve the accuracy of the estimated values of the speed-dependent resistance torques.

Note that although, in this embodiment, primary other components are subtracted from the estimated values of the resistance torques based on the simple linear dynamic model, a more strict non-linear model may be used for each component. In addition, other components may be theoretically taken into consideration. For example, the values of the deviation of the center of gravity of the vehicle body and the road surface gradient may be estimated using other observers and such components may be subtracted.

In addition, although, in this embodiment, the unrelated components are extracted based on the drive wheel rotational angular speed, conceivable other components may be extracted based on different condition(s) and may be used for correction.

The main control ECU 21 subsequently estimates the speed-dependent resistance parameters (step S1-35). In this step, the coefficients in the relational expressions of the speed-dependent resistance torques and the drive wheel rotational angular speed that are necessary to estimate the drive wheel frictional resistance coefficient, the vehicle body air resistance coefficient, and the vehicle body air resistance center height are determined using Formula 12 below, based on the time histories of the estimated drive wheel speed-dependent resistance torque, the estimated vehicle body speed-dependent resistance torque, and the drive wheel rotational angular speed.

(Expression 12)

$$[ \begin{matrix}{C}_{W , 0} & {C}_{1 , 0} \\ {C}_{W , 1} & {C}_{1 , 1} \\ {C}_{W , 2} & {C}_{1 , 2}\end{matrix} ] = {[ \begin{matrix}N & {Ω}_{1} & {Ω}_{2} \\ {Ω}_{1} & {Ω}_{2} & {Ω}_{3} \\ {Ω}_{2} & {Ω}_{3} & {Ω}_{4}\end{matrix} ]}^{- 1} [ \begin{matrix}{T}_{W , 0} & {T}_{1 , 0} \\ {T}_{W , 1} & {T}_{1 , 1} \\ {T}_{W , 2} & {T}_{1 , 2}\end{matrix} ] \qquad Formula 12$$

In this Formula,

$${Ω}_{1} = {\sum }_{k = n - N + 1}^{n} {\dot{θ}}_{W}^{( k )}$$

$${T}_{W , 0} = {\sum }_{k = n - N + 1}^{n} {τ}_{W , DV}^{( k )}$$

$${T}_{1 , 0} = {\sum }_{k = n - N + 1}^{n} {τ}_{1 , DV}^{( k )}$$

$${Ω}_{2} = {\sum }_{k = n - N + !}^{n} {\dot{θ}}_{W}^{{( k )}^{2}}$$

$${T}_{W , 1} = {\sum }_{k = n - N + 1}^{n} {\dot{θ}}_{W}^{( k )} {τ}_{W , DV}^{( k )}$$

$${T}_{1 , 1} = {\sum }_{k = n - N + 1}^{n} {\dot{θ}}_{W}^{( k )} {τ}_{1 , DV}^{( k )}$$

$${Ω}_{3} = {\sum }_{k = n - N + 1}^{n} {\dot{θ}}_{W}^{{( k )}^{3}}$$

$${T}_{W , 2} = {\sum }_{k = n - N + 1}^{n} {\dot{θ}}_{W}^{{( k )}^{2}} {τ}_{W , DV}^{( k )}$$

$${T}_{1 , 2} = {\sum }_{k = n - N + 1}^{n} {\dot{θ}}_{W}^{{( k )}^{2}} {τ}_{1 , DV}^{( k )}$$

$${Ω}_{4} = {\sum }_{k = n - N + 2}^{n} {\dot{θ}}_{W}^{{( k )}^{4}} .$$

N represents the number of data referred to and is a predetermined value.

The above Formula 12 is an expression used for the calculation, in which the relation between each speed-dependent resistance torque and the drive wheel rotational angular speed is assumed to be a quadratic function and the coefficients thereof are estimated by the least squares method.

FIG. 20 is a diagram for explaining the estimation of the parameters of the drive wheel speed-dependent resistance torque, where the vertical axis indicates the drive wheel speed-dependent resistance torque and the horizontal axis indicates the drive wheel rotational angular speed. The hollow circles, “o”, are plots of the values of the drive wheel speed-dependent resistance torque that are estimated between a current time and a time preceding to the current time by a predetermined time period, and the corresponding values of the drive wheel rotational angular speed. The curve B is a result obtained by the least squares method by approximating, by a quadratic function represented by Formula 13 below, the relation between the estimated values of the drive wheel speed-dependent resistance torque and the values of the drive wheel rotational angular speed that is shown by the plurality of the hollow circles “o”.

(Expression 13)

τ_{W,DV}=C_{W,2}\dot{θ}_{W}²+C_{W,1}\dot{θ}_{W}+C_{W,0} Formula 13

FIG. 21 is a diagram for explaining the estimation of the parameters of the vehicle body speed-dependent resistance torque, where the vertical axis indicates the vehicle body drive wheel speed-dependent resistance torque and the horizontal axis indicates the vehicle body rotational angular speed. The hollow circles, “o”, are plots of the values of the vehicle body speed-dependent resistance torque that are estimated between a current time and a time preceding to the current time by a predetermined time period, and the corresponding values of the drive wheel rotational angular speed. The curve C is a result obtained by the least squares method by approximating, by a quadratic function represented by Formula 14 below, the relation between the estimated values of the vehicle body speed-dependent resistance torque and the values of the drive wheel rotational angular speed that is shown by the plurality of the hollow circles “o”.

(Expression 14)

τ_{1,DV}=C_{1,2}\dot{θ}_{W}²+C_{1,1}\dot{θ}_{W}+C_{1,0} Formula 14

Next, the drive wheel frictional resistance coefficient, the vehicle body air resistance coefficient, and the vehicle body air resistance center height are estimated based on the obtained values of the coefficients in the relational expression of the speed-dependent resistance torques and the drive wheel rotational angular speed. Specifically, the value of the drive wheel frictional resistance coefficient, D_{W}, is estimated using the equation, D_{W}=C_{W,1}, the value of the vehicle body air resistance coefficient D₁ is estimated using the equation, D₁=C_{W,2}/R_{W}, and the vehicle body air resistance center height, h_{1,D}, is estimated using the equation, h_{1,D}=(C_{1,2}+R_{W})/D₁.

In this way, in the present embodiment, the speed-dependent resistance parameters are estimated based on the time histories of the vehicle speed and the estimated value of the speed-dependent resistance torque. Specifically, the correlation between the drive wheel rotational angular speed and the speed-dependent resistance torques and the parameters thereof are estimated using the drive wheel rotational angular speed and the estimated values of the drive wheel speed-dependent resistance torques between a current time and a time preceding to the current time by a predetermined time period. In this case, the parameters are determined by the least squares method. In this calculation, it is assumed that the speed-dependent resistance torque is expressed by three terms, which are a constant term, a term of the first degree in the drive wheel rotational angular speed and a term of the second degree in the drive wheel rotational angular speed.

Note that although, in a theoretical dynamic model, the drive wheel speed-dependent resistance torque is expressed by a term of the first degree and a term of the second degree and the vehicle body speed-dependent resistance torque is expressed by a term of the second degree only, the degree of influence of the factor(s) that is/are not taken into consideration in the dynamic model, on the estimated values of the speed-dependent resistance parameters is reduced by assuming that each expression includes another/other term(s).

Then, the speed-dependent resistance parameters are determined based on the correlation coefficients. Specifically, the drive wheel frictional resistance coefficient is determined based on the coefficient of the first degree term of the drive wheel speed-dependent resistance torque. The vehicle body air resistance coefficient is determined based on the coefficient of the second degree term of the drive wheel speed-dependent resistance torque. The vehicle body air resistance center height is determined based on the coefficient of the second degree term of the vehicle body speed-dependent resistance torque.

Although, in this embodiment, an average correlation within a predetermined period of time is estimated by the least squares method, another method may be used. For example, an average correlation can be calculated with a small memory capacity and a small amount of calculation by determining an instantaneous correlation from data of three points and subjecting each correlation parameter to a low pass filter.

In addition, although the correlation is assumed to be expressed by a quadratic function in this embodiment, a higher degree function or a different non-linear function may be used. This may make it possible to extract the speed-dependent resistance component more accurately.

The main ECU 21 performs the following target running state determination process, the following target vehicle body attitude determination process, and the following actuator output determination process, based on the speed-dependent resistance parameters estimated as described above. When it is determined that the vehicle body attitude is not stable as a result of determining whether the vehicle body attitude is stable, the main ECU 21 ends the state quantity acquisition process without estimating either of the speed-dependent resistance torques and the speed-dependent resistance parameters.

As described above, in this embodiment, the speed-dependent resistance parameters are estimated based on the time histories of the running state, the vehicle body attitude, etc. Specifically, the parameters are estimated based on the relations between various drive wheel rotational angular speeds and the speed-dependent resistance torques. The data taken while the speed of change of the vehicle body attitude is low only are used, The estimated values for the low vehicle speed are used as the offset values for correction of the error.

This makes it possible to accurately estimate the value of the speed-dependent resistance acting on the vehicle 10 irrespective of the use state and/or the use history of the vehicle 10. By using the estimated values for the low vehicle speed state as the offset values, it is possible to perform offsetting, regarding various factors, such as an ungraspable resistance, as errors.

The present invention is not limited to the above embodiments and may be modified in various ways on the basis of the scope of the present invention, and such modifications are not excluded from the scope of the present invention.

### INDUSTRIAL APPLICABILITY

The present invention is applicable to a vehicle that utilizes inverted-pendulum attitude control.

### DESCRIPTION OF THE REFERENCE NUMERALS

10 VEHICLE
12 DRIVE WHEEL
14 RIDE SECTION
20 CONTROL ECU
71 AIR SPEED SENSOR

1. A vehicle comprising:
a drive wheel rotatably attached to a vehicle body; and
a vehicle control device that controls an attitude of the vehicle body by controlling a drive torque applied to the drive wheel,
wherein the vehicle control device includes:
an estimation section that estimates a speed-dependent resistance torque that is at least one of a resistance torque acting on the drive wheel and/or a resistance torque acting on the vehicle body proportionally to an increase in a vehicle speed; and
an attitude control section that moves a center of gravity of the vehicle body relative to the drive wheel in an advancing direction of the drive wheel according to the speed-dependent resistance torque estimated by the estimation section.

2. The vehicle according to claim 1, wherein the vehicle control device moves the center of gravity of the vehicle body by inclining the vehicle body.

3. The vehicle according to claim 1, further comprising an active weight portion attached to the vehicle body so as to be movable with respect to the vehicle body,
wherein the vehicle control device moves the center of gravity of the vehicle body by moving the active weight portion.

4. The vehicle according to claim 1, wherein the estimation section estimates at least one of a vehicle body air resistance torque, which is a torque due to an air resistance acting on the vehicle body, a drive-wheel frictional resistance, which is a frictional resistance that impedes rotation of the drive wheel, and a reactive torque related to the air resistance.

5. A vehicle comprising:
a drive wheel rotatably attached to a vehicle body; and
a vehicle control device that controls an attitude of the vehicle body by controlling a drive torque applied to the drive wheel,
wherein the vehicle control device includes an air speed measurement section that measures an air speed, and
a center of gravity of the vehicle body is moved relative to the drive wheel in a direction of the air speed by an amount according to the air speed measured by the air speed measurement section.

6. A vehicle comprising:
a drive wheel rotatably attached to a vehicle body; and
a vehicle control device that controls an attitude of the vehicle body by controlling a drive torque applied to the drive wheel,
wherein the vehicle control device includes: an estimation section that estimates a speed-dependent resistance torque that is at least one of a resistance torque acting on the drive wheel according to the vehicle speed and a resistance torque acting on the vehicle body according to the vehicle speed based on a time history of a rotational state of the drive wheel, a time history of a position of a center of gravity of the vehicle body, and a time history of the drive torque; and
an attitude control section that controls an attitude of the vehicle body according to the speed-dependent resistance torque estimated by the estimation section.

7. The vehicle according to claim 6, wherein the estimation section estimates the speed-dependent resistance torque based on at least one of a time history of a rotational angular speed of the drive wheel, a time history of a rotational angular acceleration of the drive wheel, and a time history of an inclination angle of the vehicle body.

8. The vehicle according to claim 6, further comprising an active weight portion attached to the vehicle body so as to be movable with respect to the vehicle body,
wherein the estimation section estimates the speed-dependent resistance torque based on a time history of a relative position of the active weight portion with respect to the drive wheel.

9. The vehicle according to claim 6, wherein the estimation section estimates at least one of a vehicle body air resistance, which is an air resistance acting on the vehicle body, a vehicle body air resistance torque, which is a torque acting on the vehicle body due to the air resistance, and a drive-wheel frictional resistance torque, which is a frictional resistance that impedes rotation of the drive wheel.

10. The vehicle according to claim 6, wherein the estimation section inhibits using, in estimating the speed-dependent resistance torque, the time history within a period of time, during which a movement speed or a movement acceleration of the center of gravity of the vehicle body is equal to or higher than respective threshold values.

11. The vehicle according to claim 6, wherein the estimation section corrects the estimated speed-dependent resistance torque using, as an offset value, the speed-dependent resistance torque that is estimated when a rotational angular speed of the drive wheel is equal to or lower than a predetermined threshold.

12. The vehicle according to claim 6, further comprising a parameter determination section that determines a speed-dependent resistance parameter that is a parameter of correlation between a rotational angular speed of the drive wheel or the rotational angular speed to at least the second power and the speed-dependent resistance torque, based on a time history of a rotational angular speed of the drive wheel and a time history or histories of the estimated speed-dependent resistance torque,
wherein the estimation section estimates the speed-dependent resistance torque based on the speed-dependent resistance parameter.

13. The vehicle according to claim 12, wherein the parameter determination section determines at least one of a vehicle body air resistance coefficient, which is a ratio between the air resistance and a rotational angular speed of the drive wheel or the rotational angular speed to at least the second power, a vehicle body air resistance center height, which is a height of a center of action of the vehicle body air resistance, and a drive wheel frictional resistance coefficient, which is a ratio between the frictional resistance of the drive wheel and the rotational angular speed of the drive wheel or the rotational angular speed to at least the second power.

14. The vehicle according to claim 12, wherein the parameter determination section determines the speed-dependent resistance parameter by least squares method applied to correlative data between the rotational angular speed of the drive wheel and the estimated speed-dependent resistance torque taken between a current time and a time preceding to the current time by a predetermined time period.

15. The vehicle according to claim 12, wherein the parameter determination section determines at least one of a vehicle body air resistance coefficient, which is a ratio between the air resistance and a square of a rotational angular speed of the drive wheel, a vehicle body air resistance center height, which is a height of a center of action of the vehicle body air resistance, and a drive wheel frictional resistance coefficient, which is a ratio between the frictional resistance of the drive wheel and the rotational angular speed of the drive wheel.
